(19) United States
(12) Patent Application Publication
(10) Pub. No.: US 2023/0335890 A1
(43) Pub. Date: Oct. 19, 2023

(54) ANTENNA DEVICE FOR VEHICLE

(71) Applicant: YOKOWO CO., LTD., Kita-ku, Tokyo (JP)

(72) Inventors: Yusuke YOKOTA, Gunma (JP); Taiki MOCHIZUKI, Gunma (JP); Sadaharu KIZAWA, Gunma (JP)

(73) Assignee: YOKOWO CO., LTD., Kita-ku, Tokyo (JP)

(21) Appl. No.: 18/027,126

(22) PCT Filed: Sep. 28, 2021
(86) PCT No.: PCT/JP2021/035714

§ 371 Date: Mar. 20, 2023

(30) Foreign Application Priority Data
Sep. 28, 2020 (JP) 2020-162560

(51) Int. Cl. H01Q 1/32; H01Q 5/335

(52) U.S. Cl. CPC H01Q 1/32; H01Q 5/335

(57) ABSTRACT

An antenna device for a vehicle, comprising: an antenna base that is attached to a predetermined site of a vehicle; an antenna case forming an accommodation space with the antenna base; a first antenna portion accommodated in the accommodation space and corresponding a first frequency band; and a second antenna portion accommodated in the accommodation space and corresponding a second frequency band lower than the first frequency band, wherein at least a portion of a region of the first antenna portion and at least a portion of a region of the second antenna portion overlap each other, wherein a limiting circuit is connected to a power feeding portion of at least one antenna portion of the first antenna portion and the second antenna portion, and wherein the limiting circuit limits transmission of signals with frequencies outside a frequency band corresponded by the antenna portion.

### TECHNICAL FIELD

The present disclosure relates to an antenna device for a vehicle in which a plurality of antenna portions corresponding different frequency bands are arranged close to each other in a limited space.

### BACKGROUND ART

As the antenna device for a vehicle, an antenna device described in Patent Literature 1 is known. The antenna device is used for receiving AM/FM broadcasting and includes an umbrella element configuring an antenna assembly with a coil to improve gain and the like while achieving a low profile. The umbrella element is a plate-shaped conductor that has an umbrella shape when viewed from the front and from the back, and a top portion and an inclined portion extending toward a base with the top portion as a center are integrally formed.

In recent years, antenna devices that receive not only AM/FM broadcasting but also digital terrestrial television broadcasts (may be also called DTTV (Digital Terrestrial Television), and DTTB (Digital Terrestrial Television Broadcasting)) have been popular.

FIG. 31A is a schematic sectional view of a typical antenna device 200 of this kind. In the antenna device 200, a first antenna portion 12 corresponding a DTTV band, a second antenna portion 13 corresponding AM/FM bands, a first circuit input portion 14 for the DTTV band, a second circuit input portion 15 for the AM/FM bands, and circuit boards 16A and 16B on which electronic circuits (tuning circuits and the like) for the respective frequency bands are installed are loaded on an antenna base 18 sealed with an antenna case 11.

On the antenna base 18, an attaching portion 17 for attaching the antenna device 200 to a vehicle is mounted. The first antenna portion 12 and the second antenna portion 13 are separated by a fixed distance or more, and thereby coupling between the antenna portions is suppressed.

### PRIOR ART DOCUMENTS

### Patent Literature

Patent Literature 1: Japanese Patent Laid-Open No. 2012-204996

### SUMMARY OF INVENTION

### Technical Problem

In the antenna device disclosed in Patent Literature 1, the umbrella element is plate-shaped and has the inclined portion, so that if an antenna portion for the DTTV band exists near the umbrella element, mutual interference or the like may occur and influence the characteristics (such as gain and directivity). Further, the antenna devices are desired to be compact and low-profile, and in order to make the antenna device 200 with the configuration shown in FIG. 31A compact and low-profile, it is necessary to reduce a physical length of the first antenna portion 12 as shown in an antenna device 201 in FIG. 31B. Accordingly, not only it is difficult to match the impedance, but also the gain and the like are reduced by the amount of the reduced physical length.

One example of an object of the present disclosure is to make it possible to arrange a plurality of antenna portions closely in a limited space while suppressing degradation of characteristics of the mutual antenna portions in an antenna device for a vehicle having the plurality of antenna portions for different frequency bands. Other objects of the present disclosure will become apparent from the description herein.

### Solution to the Problems

An antenna device for a vehicle that is one aspect of the present disclosure includes an antenna base that is attached to a predetermined site of a vehicle, an antenna case forming an accommodation space with the antenna base, a first antenna portion accommodated in the accommodation space and corresponding a first frequency band, and a second antenna portion accommodated in the accommodation space and corresponding a second frequency band lower than the first frequency band, wherein at least a portion of a region of the first antenna portion and at least a portion of a region of the second antenna portion overlap each other, wherein a limiting circuit is connected to a power feeding portion of at least one antenna portion of the first antenna portion and the second antenna portion, and wherein the limiting circuit limits transmission of signals with frequencies outside a frequency band corresponded by the antenna portion.

### Advantageous Effects of the Invention

According to the above-described configuration of the present disclosure, it is possible to dispose the plurality of antenna portions closely in the limited space while suppressing degradation of the characteristics of the mutual antenna portions in the antenna device having the plurality of antenna portions corresponding the different frequency bands.

### BRIEF DESCRIPTION OF DRAWINGS

FIG. 1 is a schematic view of a configuration example of an antenna device for a vehicle.

FIG. 2 is an explanatory view showing a schematic sectional view, a schematic rear view, and a schematic plan view of the antenna device for a vehicle.

FIG. 3A is a sectional view of an antenna device for a vehicle of a first reference example.

FIG. 3B is a sectional view of an antenna device for a vehicle of a second reference example.

FIG. 4 is a graph showing a measurement result of gain in a DTTV band.

FIG. 5 is a schematic view of a configuration example of an antenna device for a vehicle having a limiting circuit.

FIG. 6 is an explanatory diagram of a band elimination filter (BEF) that is one example of the limiting circuit.

FIG. 7 is an explanatory view showing a schematic sectional view, a schematic rear view, and a schematic plan view of the antenna device in FIG. 5.

FIG. 8 is a graph showing a measurement result of gain in the DTTV band.

FIG. 9 is a sectional view of an antenna device for a vehicle of a third reference example.

FIG. 10A is a graph showing a result of measuring reflection characteristics on a second antenna portion side from a second circuit input portion.

FIG. 10B is a graph showing a result of measuring reflection characteristics on a first antenna portion side from a first circuit input portion.

FIG. 11 is a graph showing a measurement result of gain in the DTTV band.

FIG. 12 is a graph showing a relationship with a gain change amount to isolation.

FIG. 13 is a schematic view of a configuration example of an antenna device for a vehicle according to a second embodiment.

FIG. 14 is a graph showing a measurement result of reflection characteristic of a second circuit input portion.

FIG. 15 is a graph showing a measurement result of gain in the DTTV band.

FIG. 16 is a graph showing a relationship of a frequency and isolation.

FIG. 17A is a diagram showing a variation of a configuration example of a BEF.

FIG. 17B is a diagram showing a variation of the configuration example of the BEF.

FIG. 17C is a diagram showing a variation of the configuration example of the BEF.

FIG. 18 is a graph showing a measurement result of gain in the DTTV band.

FIG. 19A is a front view showing a configuration example of a coil structure.

FIG. 19B is a top view showing the configuration example of the coil structure.

FIG. 20A is a front view showing another configuration example of the coil structure.

FIG. 20B is a top view showing the other configuration example of the coil structure.

FIG. 21A is a front view showing another configuration example of the coil structure.

FIG. 21B is a top view showing the other configuration example of the coil structure.

FIG. 22 is an explanatory view showing a front view, a left side view, a right side view, a top view and a bottom view, a perspective view seen from a right rear direction, a perspective view of the coil structure seen from the right rear direction in a state before winding a coil, a perspective view of the coil structure seen from a left front direction, and a perspective view of the coil structure seen from the left front direction in the state before winding the coil.

FIG. 23 is an exploded diagram of the antenna device for a vehicle.

FIG. 24 is a view showing a structure example in which a second antenna is formed into an umbrella shape.

FIG. 25 is a schematic diagram of a configuration example of an antenna device for a vehicle in a first modification.

FIG. 26 is a schematic diagram of a configuration example of an antenna device for a vehicle in a second modification.

FIG. 27 is a schematic diagram of a configuration example of an antenna device for a vehicle in a third modification.

FIG. 28 is a schematic diagram of a configuration example of an antenna device for a vehicle in a fourth modification.

FIG. 29 shows a plan view and a side view of an antenna device for a vehicle using a three-point type board.

FIG. 30 shows a plan view and a side view of an antenna device for a vehicle including a parasitic element.

FIG. 31A is a schematic view of a configuration example of a typical conventional antenna device.

FIG. 31B is a schematic view of a configuration example of a typical conventional antenna device.

### DESCRIPTION OF EMBODIMENTS

Hereinafter, embodiments will be described with reference to the drawings. Here, examples of a case of implementation as an antenna device for a vehicle that is attached to a vehicle roof or the like are described. In the present specification, a forward direction of a vehicle is called “front” or “forward”, whereas an opposite direction to the forward direction is called “rear” or “rearward”, and when there is no need to distinguish between the forward direction and the opposite direction, they are each called a “longitudinal direction”. Further, a right side in the forward direction of the vehicle is called “right” or a “right direction”, whereas a left side in the forward direction is called “left” or a “left direction”, and when there is no need to distinguish between right and left, they are each called a “width direction”. Further, a gravity direction of a vehicle is called “down” or “downward”, whereas an opposite direction to the vehicle gravity direction is called “up” or “upward”, and when there is no need to distinguish between the gravity direction and the opposite direction, they are each called a “vertical direction”.

### First Embodiment

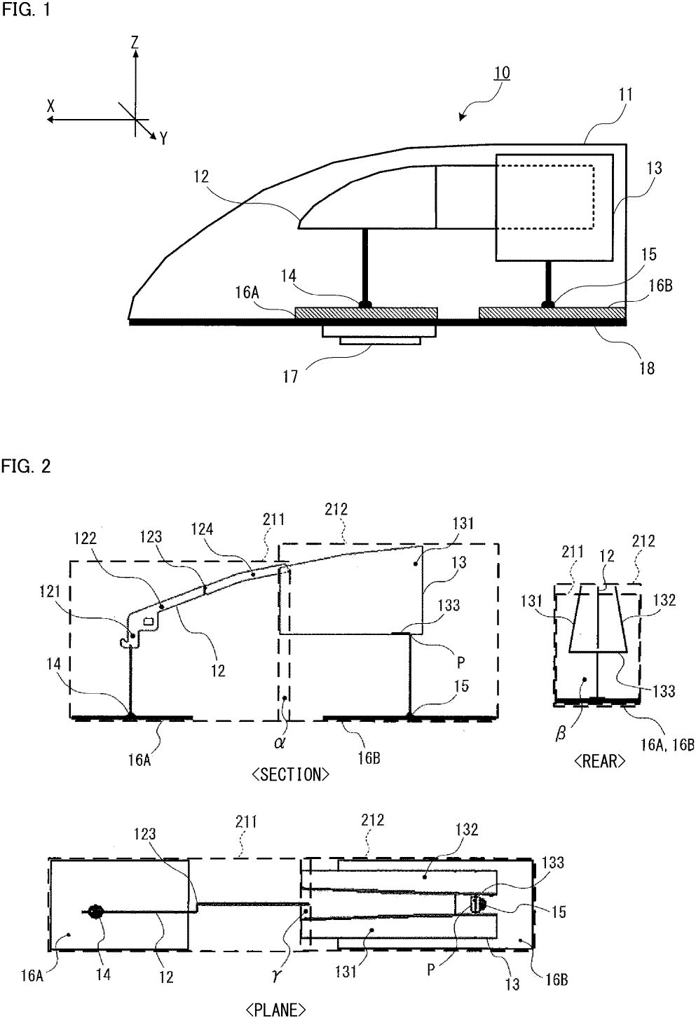

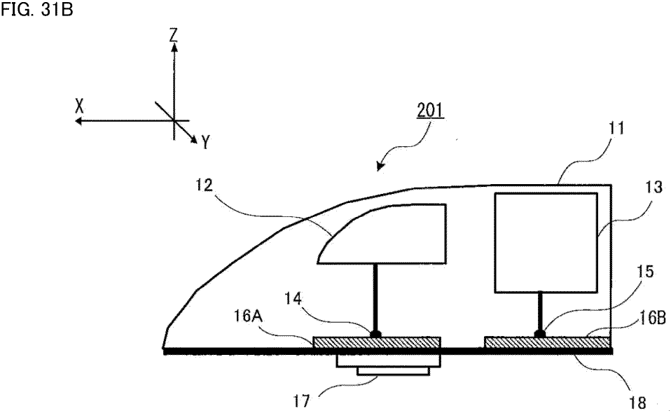

FIG. 1 is a schematic diagram of an antenna device 10 for a vehicle for explaining a first characteristic portion of the present disclosure, and components that are functionally equivalent to the antenna devices 200 and 201 of FIGS. 31A and 31B showing the conventional examples are assigned with the same reference signs for convenience. The antenna device 10 is assumed to be arranged so that when orthogonal three-dimensional axes of an X, Y and Z axes are assumed, a forward direction of the vehicle is in a positive direction of the X axis (an arrow direction), a left direction is in a positive direction of the Y axis (an arrow direction), and an up is in a positive direction of the Z axis (an arrow direction). Accordingly, a longitudinal direction of the antenna device 10 and components described later (X-axis direction in FIG. 1) corresponds to a longitudinal direction of the vehicle.

The antenna device 10 in FIG. 1 has an antenna base 18 to be attached to a predetermined site of the vehicle, for example, a vehicle roof, and an antenna case 11 that forms an accommodation space with the antenna base 18. The accommodation space is a space in which a first antenna portion 12, a second antenna portion 13, a first circuit input portion 14, a second circuit input portion 15, and circuit boards 16A and 16B are accommodated. The first antenna portion 12 functions as an antenna corresponding a first frequency band, in the present example, a DTTV band antenna. The second antenna portion 13 functions as an antenna corresponding a second frequency band, in the present example, a portion of an AM/FM band antenna. Each of the antenna portions 12 and 13 is configured by including one or more elements in a predetermined shape, and is disposed to extend in the longitudinal direction as the entire antenna portion.

On the circuit board 16A, an impedance matching circuit designed for a DTTV band, a tuning circuit, an amplifying circuit and the like are installed. On the circuit board 16B, an impedance matching circuit designed for an AM/FM band, a tuning circuit, an amplifying circuit and the like are installed. The first circuit input portion 14 is an input interface (feeder or the like) with the circuit board 16A. The second circuit input portion 15 is an input interface (feeder or the like) with the circuit board 16B. On the antenna base 18, an attaching portion 17 for attaching to a vehicle is mounted.

A rear end portion that is rearmost of elements of the first antenna portion 12, and a front end portion that is frontmost of elements of the second antenna portion 13 are placed in positions where the rear end portion and the front end portion overlap each other in side view, that is, a view from the Y-axis direction, although they are not in contact with each other (in FIG. 1, a portion shown by a dotted line represents the portions overlapping each other in the longitudinal direction). Therefore, a distance between the front end portion of the first antenna portion 12 and the rear end portion of the second antenna portion 13, that is, a length (physical length) in the longitudinal direction is shorter than a total value of a length (physical length) in the longitudinal direction when the respective elements of the first antenna portion 12 and the second antenna portion 13 do not overlap in side view.

The present disclosure is not limited to the configuration in which the rear end portion of the first antenna portion 12 and the front end portion of the second antenna portion 13 overlap each other, but may have a configuration in which a rear portion of the first antenna portion 12 and a front portion of the second antenna portion 13 overlap each other. Furthermore, a configuration in which an upper portion of the first antenna portion 12 overlaps an upper portion of the second antenna portion 13 may be adopted.

Although in FIG. 1, the first antenna portion 12 is drawn in a streamlined shape having two right-angled portions in the rear and an arc portion in the front and the second antenna portion 13 is drawn in a squared shape in side view, the respective shapes are schematically drawn for convenience of explanation. The actual shapes of the first antenna portion 12 and second antenna portion 13 may be different from the illustrated shapes according to desired antenna characteristics. For example, the first antenna portion 12 and the second antenna portion 13 can include elements in a linear shape, a planar shape, or a shape of a combination of these shapes.

FIG. 2 is an explanatory view showing a schematic sectional view in side view showing a shape and a structure of the antenna device 10 more specifically, a rear view of the antenna device 10 (that is, a view seen from a viewpoint in a -X-axis direction), and a plan view of the antenna device 10, that is, a view seen from a viewpoint (top view) in a —Z-axis direction.

In FIG. 2, a region 211 represents a region of the first antenna portion 12, and a region 212 represents a region of the second antenna portion 13. In more detail, the region 211 is a solid in a three-dimensional space including each element and the circuit board 16A of the first antenna portion 12, and is represented as a rectangular parallelepiped in the illustrated example.

A length in the X-axis direction of the region 211 is a maximum length including the first antenna portion 12 and the circuit board 16A. In the drawing, the length is defined by a left end in the X-axis direction of the circuit board 16A in the schematic sectional view and a right end in the X-axis direction of the first antenna portion 12 (right end in the X-axis direction of a fourth element 124) in the schematic sectional view.

A length in the Y-axis direction of the region 211 is a maximum length including the first antenna portion 12 and the circuit board 16A. In the drawing, the length is defined by a lower end and an upper end in the Y-axis direction of the circuit board 16A in the schematic plan view.

A length in the Z-axis direction of the region 211 is a maximum length including the first antenna portion 12 and the circuit board 16A. In the drawing, the length is defined by a lower end of the circuit board 16A and an upper end of the first antenna portion 12 (upper end of the fourth element) in the schematic rear view.

In this way, the region 211 of the first antenna portion is defined as a rectangular parallelepiped of maximum dimensions defined by the maximum lengths including the first antenna portion 12 and the circuit board 16A in the X-axis, Y-axis and Z-axis directions. Further, the circuit board 16A itself is also included in the region 211.

Similarly, the region 212 of the second antenna portion is also defined as a rectangular parallelepiped of maximum dimensions including the board 16B that is defined by maximum lengths including the second antenna portion 13 and the circuit board 16B in the X axis, Y axis and Z axis. Further, the circuit board 16B itself is also included in the region 212.

In the schematic sectional view in FIG. 2, a portion of the region 211 and a portion of the region 212 overlap each other in side view, and the overlapping regions are shown as a region α. Further, in the rear view, a portion of the region 211 and a portion of the region 212 overlap each other in rear view, and the overlapping regions are shown as a region β. Further, even when viewed from the front side of the antenna 10, that is, from a viewpoint in a +X-axis direction in rear view, there is no change in the relationship that a portion of the region 211 and a portion of the region 212 overlap each other in the region β. Accordingly, it is found that a portion of the region 211 and a portion of the region 212 also overlap each other in front view. In the plan view, the region 211 and the region 212 overlap each other in top view, and the overlapping regions are shown as a region γ. From the relationship of the region 211 and the region 212 shown in FIG. 2, it is shown that a portion of the region of the first antenna portion 12 and a portion of the region of the second antenna portion 13 overlap each other in each of top view, side view and front view.

In the example of FIG. 2, the first antenna portion 12 is configured by including a first element 121, a second element 122, a third element 123 and a fourth element 124. These elements 121 to 124 are each produced by working and molding a metal plate.

The first element 121 is an element that is conductively connected to an input interface (feeder or the like) extending in the vertical direction from the antenna base 18 (or the circuit board 16A) and functions as a power feeding portion of the first antenna portion 12. The input interface extending vertically also functions as an antenna, and the first circuit input portion 14 functions as a power feeding portion.

The second element 122 is an element extending upward at a predetermined angle to the X axis from one end of the first element 121. The third element 123 is an element that is bent in a width direction from an end portion in an opposite direction to the first element 121, of the second element 122. The fourth element 124 is an element that further extends upward at a predetermined angle to the X axis from an end portion in an opposite direction to the second element 122, of the third element 123.

The third element 123 is formed to shorten a length (physical length) in the longitudinal direction from a tip end portion of the first element 121 to a rear end portion of the fourth element 124 while maintaining a conductor area and an electric length of the whole elements of the first antenna portion 12 more than a case where the third element 123 does not exist. The third element 123 may be an element that forms a curved portion that is curved in the width direction from the end portion in the opposite direction to the first element 121, of the second element 122.

The second antenna portion 13 is configured by a pair of inclined elements 131 and 132 formed of a metal plate with an opposing space decreasing toward end portions in upper portions (upper end portions), and a connection element 133 that is a thin metal plate connecting the respective inclined elements 131 and 132 at end portions in lower portions. An input interface that vertically extends from the antenna base 18 (or the circuit board 16B) to the connection element 133 also functions as an antenna. The connection element 133 functions as a power feeding portion with the second circuit input portion 15 of the second antenna portion 13.

In the antenna device 10 of the configuration like this, a portion (rear end portion) of the fourth element 124 of the first antenna portion 12 overlaps portion (front end portions) of the pair of inclined elements 131 and 132 of the second antenna portion 13 in the longitudinal direction.

The shapes and structures of the first antenna portion 12 and the second antenna portion 13 are not limited to the example shown in FIG. 2. For example, the first element 121, the second element 122, the third element 123 and the fourth element 124 of the first antenna portion 12 may cover an upper end portion of an insulating board having front and back surfaces, or may be fixed to a vicinity of the upper end portion. In this case, the first element 121 and the second element 122 can be formed on a front surface side of the insulating board, the fourth element 124 can be formed on a back surface side of the insulating board, and the third element 123 can be formed as a conductive chip or a conductive plate that electrically connects the front surface side and the back surface side of the insulating board.

Further, it is also possible to further shorten a length (physical length) in the longitudinal direction of the first antenna portion 12, and also including the second antenna portion 13, by increasing the number of bent portions by increasing the number of elements of the first antenna portion 12. As a configuration of increasing the number of bent portions, an accordion shape, a meander shape, a helical shape and the like are cited, for example. In other words, even when the length in the longitudinal direction of the antenna base 18 is shorter than that of the conventional antenna device 200 for a vehicle shown in FIG. 31A, the electrical length that is the same length as in the conventional antenna device 200 is ensured, so that it is possible to enhance radiation efficiency.

A DTTV signal received by the first antenna portion 12 is transmitted to an electronic circuit of the circuit board 16A via the first circuit input portion 14. Further, an AM/FM signal received by the second antenna portion 13 is transmitted to an electronic circuit of the circuit board 16B via the second circuit input portion 15.

In the schematic sectional view in FIG. 2, a portion of the first antenna portion 12 is shown by a dotted line, and this shows portion of the element that overlaps the second antenna portion 13 in side view although the portion of the element separates from the second antenna portion 13 in top view, similarly to the schematic view in FIG. 1.

In this way, in the antenna device 10, the portion of the element of the first antenna portion 12, and the portion of the element of the second antenna portion 13 overlap each other in the longitudinal direction in side view, and further, the first antenna portion 12 has the third element 123 bent in the width direction. Therefore, when the entire length of the first antenna portion 12 is the same, it is possible to make the length (physical length) in the longitudinal direction shorter than the length in the case where no bent portion exists by mounting the third element 123 that is the bent portion. On the other hand, when the first antenna portion 12 is configured by the first element 121, the second element 122, and the fourth element 124 without having the bent portion, the entire length is shorter than that in the case of having the third element 123, so that the antenna characteristics are degraded. Accordingly, it is possible to make the antenna device 10 compacter without degrading the antenna characteristics by mounting the third element 123 that is the bent portion.

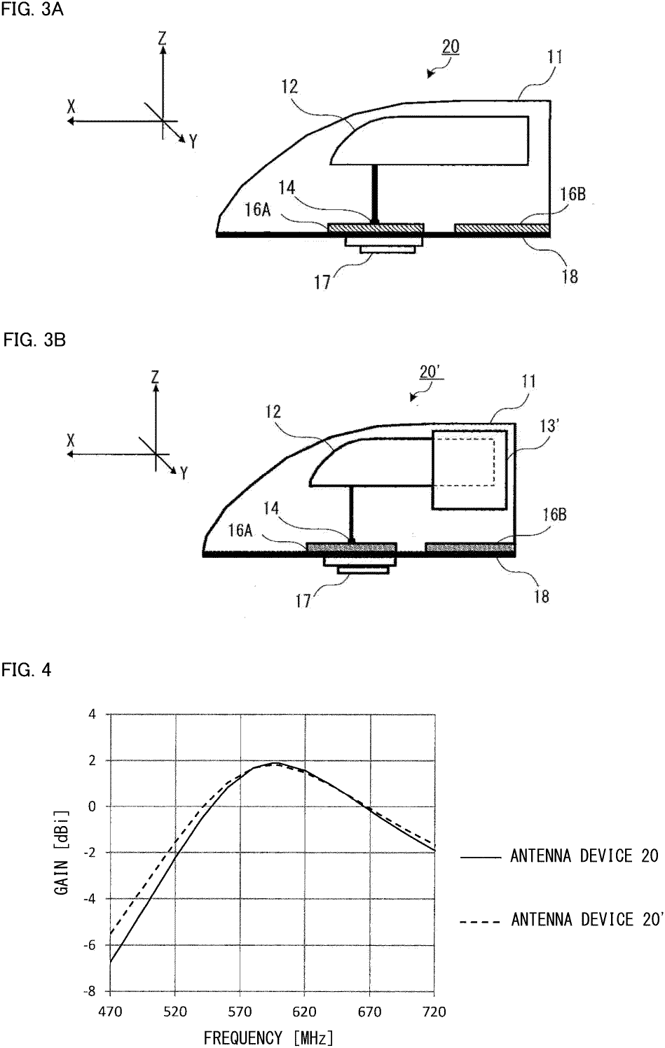

An antenna device 20 for a vehicle of a first reference example shown in FIG. 3A and an antenna device 20′ for a vehicle of a second reference example shown in FIG. 3B will be described. Antenna characteristics of the antenna device 20 of the first reference example and the antenna device 20′ of the second reference example are compared and described. As shown in FIG. 3A, the antenna device 20 has a planarized configuration in which the second antenna portion 13 is excluded from the antenna device 10, and the first antenna portion 12 does not have the bent third element 123. Components other than the first antenna portion 12 and the second antenna portion 13 in the antenna device 20 of the first reference example are the same as the components of the antenna device 10. That is to say, the antenna device 20 of the reference example has only a first antenna portion 12 corresponding the DTTV band, and is not influenced by the AM/FM band, harmonics of the FM band, and the like.

As shown in FIG. 3B, the antenna device 20′ of the second reference example is common to the antenna device 20 in that the first antenna portion 12 does not have the bent third element 123. However, the antenna device 20′ differs from the antenna device 20 in that the antenna device 20′ has a second antenna portion 13′, and further has a configuration different from the antenna device 10 in that the second antenna portion 13′ is not connected to a circuit board 16B.

Components other than the second antenna portion 13′ that is not connected to the circuit board 16B in the antenna device 20′ of the second reference example are the same as the components of the antenna device 20. In other words, the antenna device 20′ of the reference example 2 has a first antenna portion 12 corresponding the DTTV band, and also has the second antenna portion 13′, but the second antenna portion 13′ is not connected to the circuit board 16B, and therefore the antenna device 20′ is not influenced by the AM/FM band, harmonics of the FM band, and the like. On the other hand, the antenna device 20′ receives an influence of the second antenna portion 13′ as a capacitive plate.

FIG. 4 is a frequency-gain characteristic diagram in the DTTV band. An axis of ordinates represents a gain (DTTV Gain [dBi]), and an axis of abscissa represents a frequency (Frequency [MHz]). In FIG. 4, a gain characteristic in the antenna device 20 is represented by a solid line, and a gain characteristic in the antenna device 20′ is represented by a broken line. Referring to FIG. 4, the antenna device 20′ in FIG. 3B in which portion of elements of the first antenna portion 12 overlaps portion of elements of the second antenna portion 13′ in side view is substantially equivalent to the antenna device 20 in gain in a vicinity of a central portion of the DTTV band, that is, in a frequency in a vicinity of approximately 580 MHz to approximately 660 MHz. However, in ranges of approximately 470 MHz to approximately 580 MHz that is a frequency range at a low side of the DTTV band, and approximately 660 MHz to approximately 720 MHz that is a frequency range at a high side of the DTTV band, a gain of the antenna device 20′ is larger than the gain of the antenna device 20. In other words, it is shown that the gain increases by an influence of the second antenna portion 13′ as a capacitive loading plate, and broadband is achieved.

This is because in the antenna device 10, portion of the elements of the first antenna portion 12 is close to the elements of the second antenna portion 13, whereby nearest elements are capacitively coupled, and capacitive impedance of the other elements is added in parallel, as a result of which, an apparent antenna size (electrical length) becomes large. In other words, this is because the second antenna portion 13 for the AM/FM band acts as a capacitive loading element that loads capacitance to the first antenna portion 12 for the DTTV band.

A positional relationship of the first antenna portion 12 and the second antenna portion 13 and an effect of achievement of broadband in the DTTV band by the positional relationship are as described above, and it is also necessary to consider electrical characteristics of the second antenna portion 13 in the AM/FM band and the DTTV band.

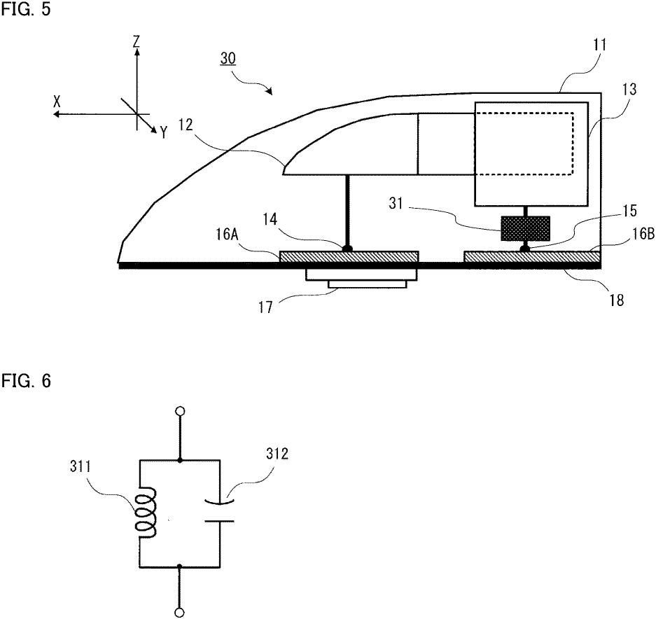

In the first embodiment, as shown in a schematic view in FIG. 5, an antenna device 30 for a vehicle is adopted, in which a limiting circuit 31 that limits transmission of signals of frequencies other than the AM/FM band while allowing transmission of signals in the AM/FM band is interposed between a second antenna portion 13 and a second circuit input portion 15.

Components of the antenna device 30 other than the limiting circuit 31 are the same as the components of the antenna device 10.

As the limiting circuit 31, in a simple example, it is possible to use a BEF (Band Elimination Filter) in which an inductive element (inductor) 311 and a capacitive element (capacitor or the like) 312 are connected in parallel, as shown in FIG. 6. An electrical constant of the BEF is an impedance value (parallel resonance state) that is so high as to inhibit transmission of signals in the DTTV band, for example, but in the frequencies outside the DTTV band, the BEF does not resonate so that transmission of signals is allowed. In particular, in the AM/FM band, the BEF acts as an inductor, and therefore, an influence on the antenna characteristics in the AM/FM band, for example, gain is infinitesimally small.

The antenna device 30 having the limiting circuit 31 like this can suppress reduction in gain of the first antenna portion 12 by being connected to the circuit board 16B while maintaining the effect of achievement of broadband of frequencies in use in the DTTV band. The BEF can be configured by using self-resonant (Self-Resonant) of the inductor. “Self-Resonant” refers to a resonance phenomenon due to minute distributed capacitance that occurs between winding conductors and between terminals or the like where the inductor has a coil structure. Existence of the distributed capacitance often becomes a problem because the distributed capacitance is not manifested at a time of design, but in the present embodiment, it is possible to reduce the number of components, and contribute to reduction in size and weight of the antenna device 30, by configuring the BEF by positively using the distributed capacitance. Alternatively, a high-cut filter that inhibits passage of signals with frequencies higher than the FM waveband may be used, instead of the BEF.

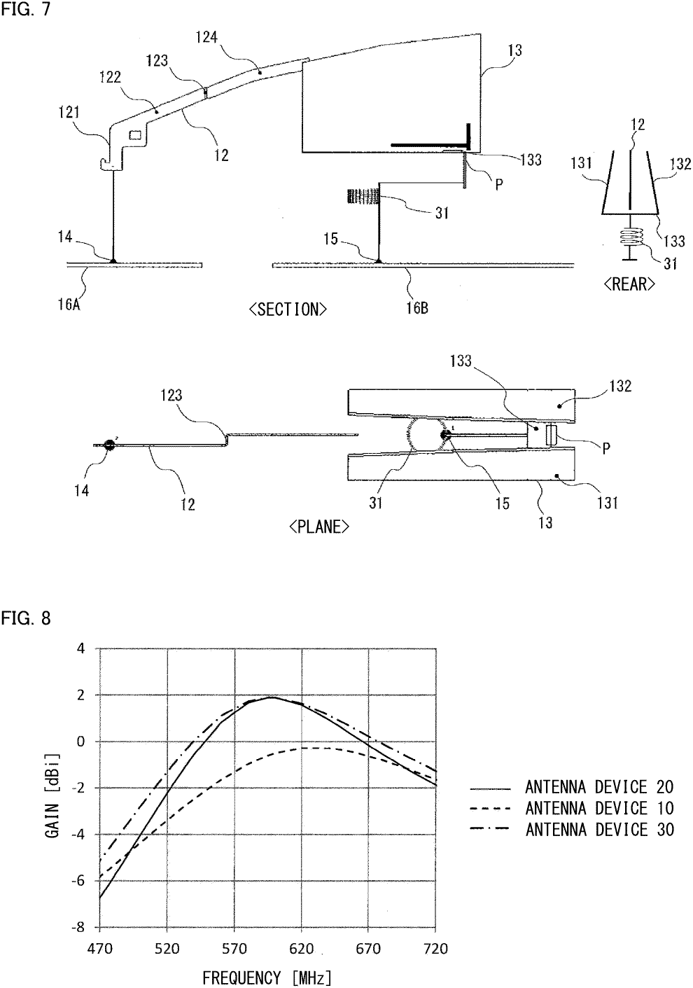

FIG. 7 is an explanatory view showing a schematic view in side view showing the shape and the structure of the antenna device 30 more specifically, a rear view of the antenna device 30, that is, a plan view in a viewpoint in a -X-axis direction, and a top view of the antenna device 30, that is, a plan view in a viewpoint in a —Z-axis direction. As the limiting circuit 31, a helical element that is an example of an inductor element is used.

In FIG. 7, the first antenna portion 12, the second antenna portion 13 and the like have same configurations as in FIG. 2. In the helical element, a contact P is connected to a connection element 133 to be a power feeding portion of the second antenna portion 13, but a center axis thereof is arranged at a relatively front portion or rear portion away from the connection element 133. This is to prevent magnetic lines of force generated from the helical element from causing electromagnetic induction in the inclined elements 131 and 132 of the second antenna portion 13.

FIG. 8 is a frequency-gain characteristic diagram in the DTTV band. An axis of ordinates represents a gain (DTTV Gain [dBi]), and an axis of abscissa represents a frequency (Frequency). In FIG. 8, a gain characteristic in the antenna device 10 is represented by a broken line, a gain characteristic in the antenna device 20 of the first reference example is represented by a solid line, and a gain characteristic of the antenna device 30 having the limiting circuit 31 is represented by an alternate long and short dash line.

The gain characteristic in the DTTV band of the antenna device 20 is the same as in FIG. 4. A maximum gain in a frequency in a vicinity of a central portion of the DTTV band of the antenna device 30 having the limiting circuit 31 is 1.9 (dBi) and is equivalent to 1.9 (dBi) that is a maximum value of the gain of the antenna device 20. In other words, reduction in the gain in the DTTV band is suppressed by the limiting circuit 31 much more than in the antenna device 10. On the other hand, in a range of approximately 470 MHz to approximately 580 MHz that is a low side frequency in the DTTV band, and a range of approximately 620 MHz to approximately 720 MHz that is a high side frequency in the DTTV band, gains in the DTTV band become larger than in the antenna device 10 and the antenna device 20 of the first reference example. In other words, a difference between the maximum value and a minimum value of the gain in the DTTV band becomes smaller, and broadband of the frequencies in use is achieved.

It has been found that not only gain reduction in the DTTV band is suppressed, but also a broader band is possible by bringing the element of the first antenna portion 12 and the element of the second antenna portion 13 close to each other so that mutual portions overlap each other without changing the physical lengths of the element of the first antenna portion 12 and the element of the second antenna portion 13 by interposing the limiting circuit 31 between the second antenna portion 13 and the second circuit input portion 15 in this way.

In the first embodiment, the example of the case in which the inclined elements 131 and 132 of the second antenna portion 13 are metal plates is described, but a plurality of gaps may be formed in each of the inclined elements 131 and 132. By providing the gaps, it is possible to attach the second antenna portion 13 by only fitting projections or the like of a holder of a resin or an insulating material not illustrated and fixed to the antenna case 11 or the antenna base 18, for example, into the gaps. Further, it is possible to use the gaps as means for fine adjustment of the electrical length of the second antenna portion 13. A portion or a whole of each of the inclined elements 131 and 132 may be a conductor plate in a fractal shape, a meander shape, or a shape partially including these shapes having gaps. Thereby, fine tuning of the antenna characteristics of the second antenna portion 13 is enabled. The same also applies to the elements of the first antenna portion 12.

In the first embodiment, the example in which the limiting circuit 31 is interposed between the second antenna portion 13 and the second circuit input portion 15 is described, but if the limiting circuit 31 is arranged between the second circuit input portion 15 of the circuit board 16B and a subsequent-stage circuit to the second circuit input portion 15, it is possible to obtain a similar effect to the effect of the antenna device 30.

### Second Embodiment

Next, an antenna device for a vehicle according to a second embodiment will be described. As in the antenna device shown in Patent Literature 1, in the AM/FM band, a coil may be used as portion of elements of an antenna portion. A coil is adjusted to resonate in the FM band range when the coil is combined with another element (the umbrella element in the example of Patent Literature 1), but when a harmonic component of this resonance frequency reaches a frequency of the DTTV band, it becomes a factor that reduces a gain in the DTTV band. In the second embodiment, an example of an antenna device of a configuration that excludes the factor like this will be described.

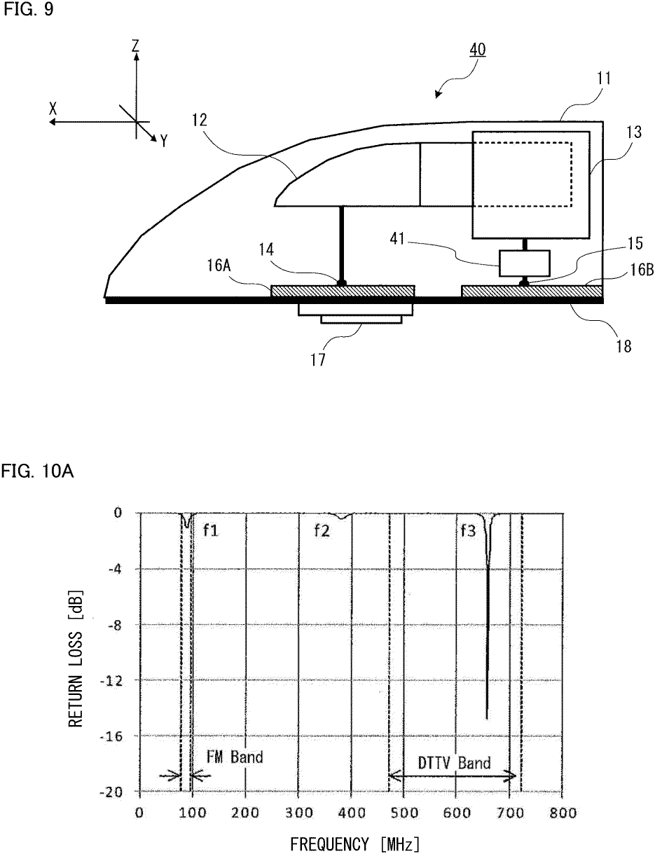

FIG. 9 is a sectional view of an antenna device 40 for a vehicle of a third reference example, components with same functions as the components of the antenna devices 10, 20, and 30 described in the first embodiment are assigned with the same reference signs for convenience. The antenna device 40 of the third reference example is used for comparison explanation with antenna characteristics of an antenna device 50 for a vehicle of the second embodiment described later, and is such that in a similar configuration to the configuration of the antenna device 10 of the first embodiment, a helical element 41 is arranged between the second antenna portion 13 and the second circuit input portion 15. The helical element 41 is designed to resonate in the FM band with the second antenna portion 13.

A graph showing a measurement result of reflection characteristics on a second antenna portion 13 side from a second circuit input portion 15 in the antenna device 40 of the third reference example is shown in FIG. 10A. An axis of ordinates in FIG. 10A represents a return loss (dB), and an axis of abscissa represents a frequency (MHz). Referring to FIG. 10A, in the antenna device 40, a first harmonic component (f2: 380 MHz) and a third harmonic component (f3: near 655 MHz) due to the helical element 41 occur, in addition to a resonance frequency (f1: near 90 MHz) due to the helical element 41 and the second antenna portion 13. The third harmonic component f3 is a frequency belonging to the DTTV band, and the third harmonic component f3 unfavorably influences antenna characteristics of the first antenna portion 12.

Further, a graph showing a measurement result of reflection characteristics on a first antenna portion 12 side from a first circuit input portion 14 in the antenna device 40 of the third reference example is shown in FIG. 10B. An axis of ordinates in FIG. 10B represents a return loss (dB), and an axis of abscissa represents a frequency (MHz).

Referring to FIG. 10B, in the DTTV band, a return loss (Return Loss) increases to approximately —5 dB due to the influence of the third harmonic component f3 of the FM band. This is considered to be because the third harmonic component f3 generated on the second antenna portion 13 side interferes with the elements of the first antenna portion 12, and unnecessary resonance occurs in the DTTV band. When unnecessary resonance occurs, gain in the DTTV band decreases, and signal reproduction may not be possible regardless of a posture of the vehicle.

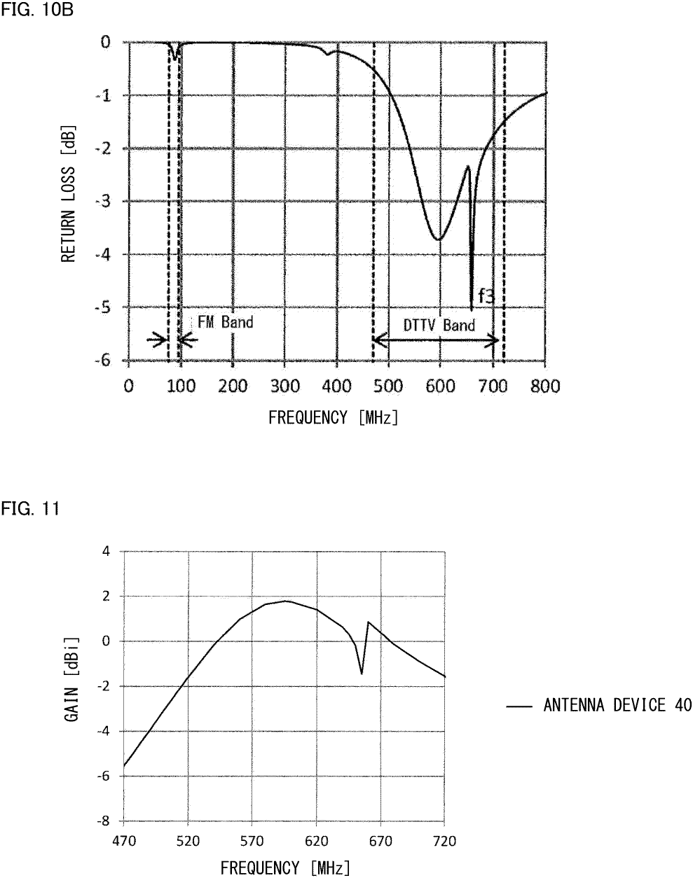

There is isolation as a parameter representing a degree of signal separation between the first antenna portion 12 and the second antenna portion 13. The isolation can be expressed by a transmission characteristic (dB) or the like between the antenna portions. FIG. 11 is a graph showing a measurement result of gain in the DTTV band in the antenna device 40 of the third reference example. An axis of ordinates represents gain (dB) in the DTTV band, and an axis of abscissa represents a frequency (MHz). As illustrated, it is shown that unnecessary resonance occurs due to an influence of harmonics in the FM waveband in a vicinity of the frequency 655 MHz and the gain in the DTTV band is reduced. Thus, a distance between a rear end portion of the first antenna portion 12 and a front end portion of the second antenna portion 13 is increased from the state shown in FIG. 9 to change the isolation. A graph expressing a relationship between the isolation (transmission characteristic: dB) and a change amount of the gain (dB) at this time is shown in FIG. 12. The gain (dB) of the axis of ordinates is shown as a change amount from a reference by using gain as the reference, which is obtained when the helical element 41 that is an inductive element is not mounted and harmonics in the FM waveband do not occur in the DTTV band.

Referring to FIG. 12, when the isolation is -10.5 dB, the change amount of the gain becomes -0.4 dB. When the change amount of the gain is suppressed to a small value of -0.4 dB in this way, the first antenna portion 12 and the second antenna portion 13 are located in positions separated by 12.5 mm in the antenna longitudinal direction, and a total length of the first antenna portion 12 and the second antenna portion 13 is 115.5 mm. Further, it is found that when the isolation is worsened from -10.5 dB, a reduction amount of the gain increases, and in particular, when the isolation becomes —4 dB or more, the gain abruptly decreases.

Further, since the harmonics occur due to a resonance phenomenon of the second antenna portion 13 and the helical element 41, impedance of the second antenna portion 13 and the helical element 41 that is an inductive element with a frequency of the resonance phenomenon is reduced. As a result, isolation from the first circuit input portion 14 to the second circuit input portion 15 may be reduced, and malfunction may occur in electronic circuits of the circuit boards 16A and 16B and a subsequent-stage system of the antenna device 40 of the third reference example. Thus, in the second embodiment, a configuration example for avoiding a phenomenon in which unnecessary resonance occurs in the DTTV band will be described.

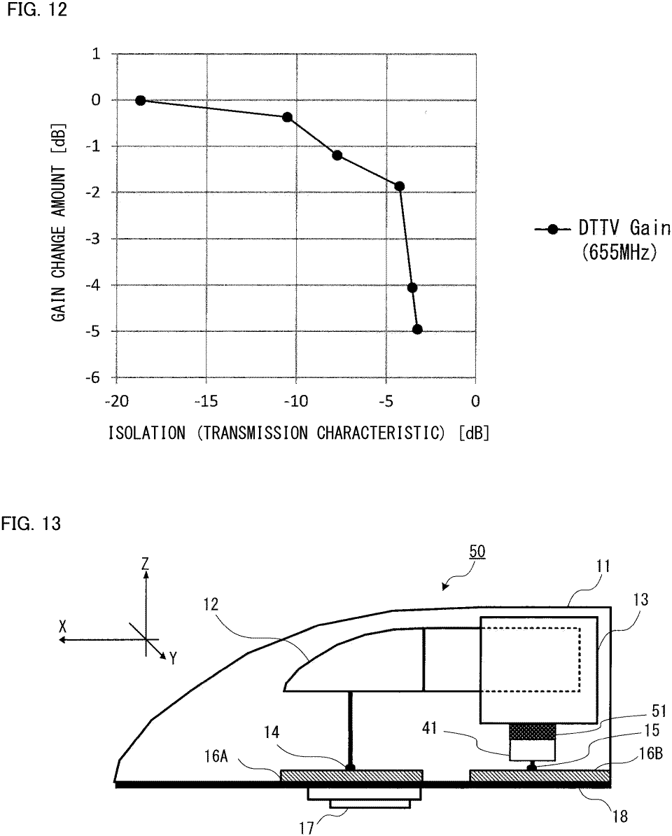

FIG. 13 is a schematic view of an antenna device 50 of the second embodiment. Similarly to the first embodiment, a shape and a structure are schematically shown. In the antenna device 50, a limiting circuit 51 is interposed between the second antenna portion 13 and the helical element 41 as an inductive element of the antenna device 40 of the third reference example shown in FIG. 9.

As the limiting circuit 51, it is possible to use a BEF in which an inductive element 311 and a capacitive element 312 are arranged in parallel, or a filter using self-resonance of an inductor of a coil structure, similarly to the limiting circuit 31 of the first embodiment shown in FIG. 6. In the second embodiment, it is also possible to use another arbitrary filter or the like if it has the configuration having high impedance in the DTTV band and low impedance in the AM/FM band. Since isolation can be ensured sufficiently by the limiting circuit 51, reduction in gain due to the influence of the harmonics in the FM band is suppressed even if a first antenna portion 12 and a second antenna portion 13 are brought so close to each other that the first antenna portion 12 and the second antenna portion 13 partially overlap each other. In the second embodiment, a physical length in the longitudinal direction of a total of the first antenna portion 12 and the second antenna portion 13 is 55.5 mm, and is made compacter by 60 mm than in the antenna device 40 of the third reference example shown in FIG. 9.

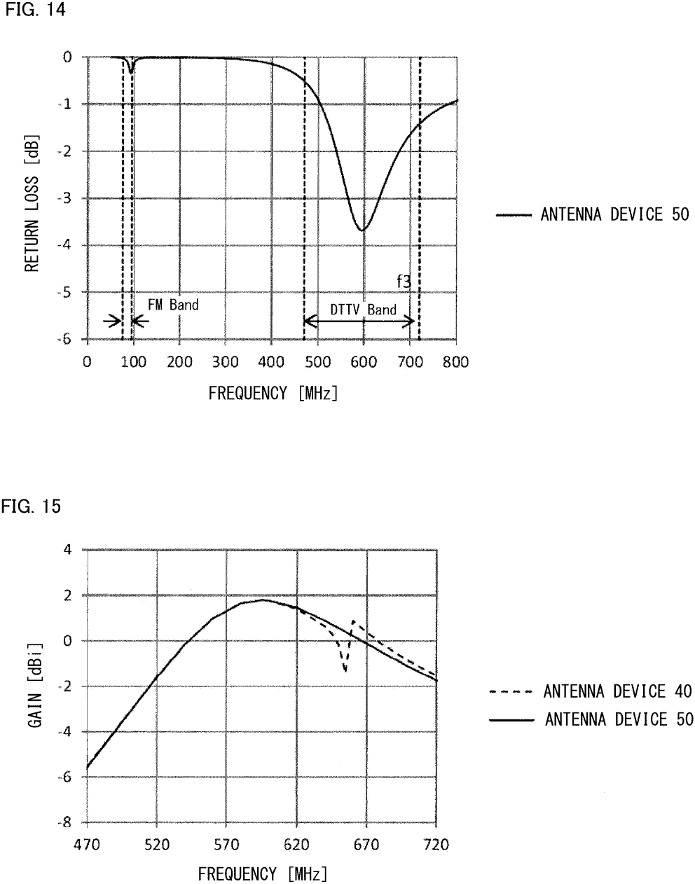

FIG. 14 is a graph showing a measurement result of a reflection characteristic of a first circuit input portion 14 in the antenna device 50. In the antenna device 40 of the third reference example, the third harmonic component f3 occurs in the DTTV band, whereas in the antenna device 50 according to the second embodiment, occurrence of a third harmonic component f3 is suppressed.

FIG. 15 is a graph showing a measurement result of gain in the DTTV band in each of the antenna device 40 of the third reference example and the antenna device 50 of the second embodiment. The gain characteristic in the antenna device 40 of the third reference example is the same as the gain characteristic shown in FIG. 11. As shown in FIG. 15, in the antenna device 40 of the third reference example, the gain abruptly decreases and increases before and after 655 MHz, an abrupt gain fluctuation by the third harmonic component f3 occurs, whereas in the antenna device 50 of the second embodiment, such a gain fluctuation does not occur. In other words, interference by the third harmonic component f3 is suppressed.

Since the limiting circuit 51 functions as an inductor in the AM/FM band, there is little influence to the gain on the second antenna portion 13.

FIG. 16 is a graph showing a relationship between a frequency and isolation. It is shown that in the antenna device 40 of the third reference example, the isolation between the first antenna portion 12 and the second antenna portion 13 is worsened in a vicinity of 655 MHz that is a frequency at which harmonics occur. On the other hand, in the antenna device 50, by mounting the limiting circuit 51, the isolation is -10.5 dB or less. As described above, when the isolation exceeds -10.5 dB, the decrease amount of the gain increases, but in the second embodiment, the limiting circuit 51 is mounted, and therefore decrease in gain is suppressed.

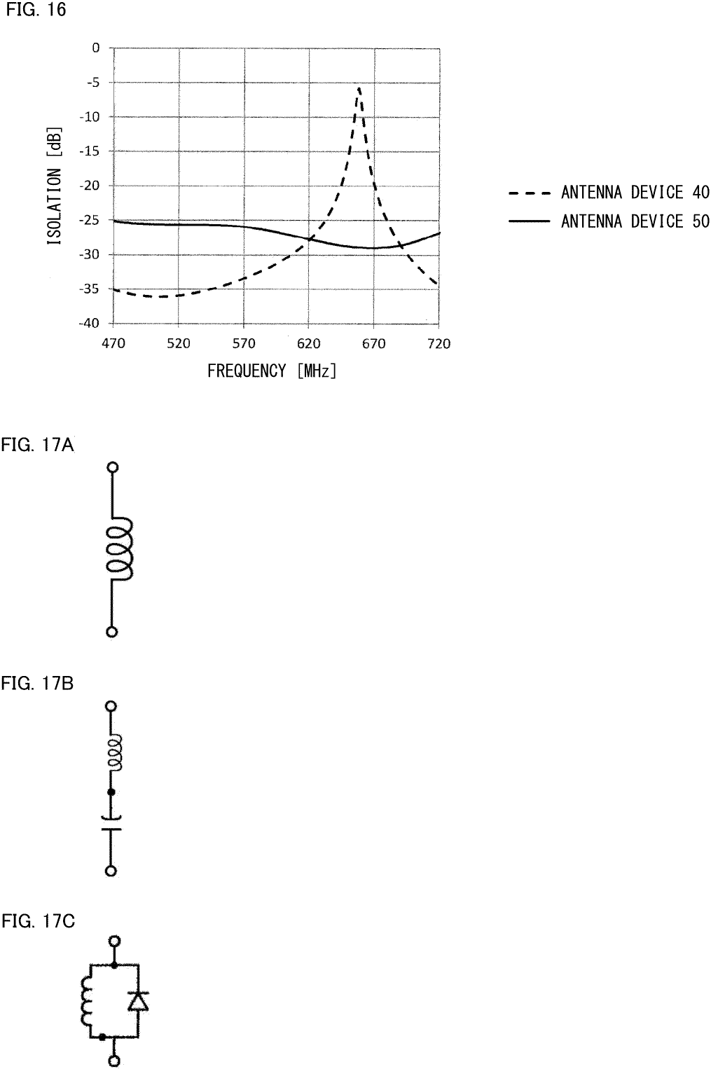

Here, the limiting circuit 51 used in the antenna device 50 will be described in more detail. FIG. 17A to FIG. 17C are explanatory diagrams of BEFs that are examples of the limiting circuit 51. FIG. 17A is an example of using a self-resonance phenomenon of a single inductive element, FIG. 17B is an example in which an inductive element and a capacitive element are connected in series, and in FIG. 17C, parallel resonance can be performed by using an inductive element and a semiconductor like a diode as a capacitive element. Further, in the case of configuring the limiting circuit 51 by using self-resonance of a coil, it is possible to integrate the limiting circuit 51 (BEF) and the helical element.

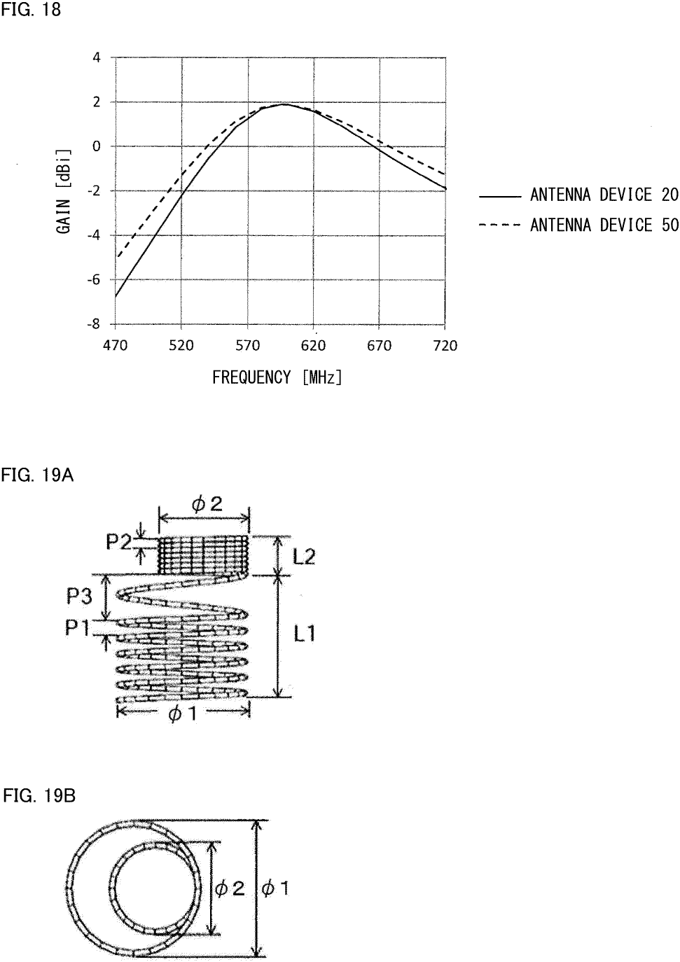

FIG. 18 is a graph showing a measurement result of a gain characteristic in the DTTV band in each of the antenna device 20 of the first reference example shown in FIG. 3A and the antenna device 50 according to the second embodiment shown in FIG. 13. In the antenna device 50, the gain improves by 1.3 dB in a vicinity of 470 MHz, and the gain improves by 0.8 dB in a vicinity of 720 MHz, as compared with the antenna device 20 of the first reference example, so that broadband of the frequency in use is achieved.

When BEF or a filter having an equivalent function is configured by using self-resonance, it is possible to realize the limiting circuit 51 and the helical element 41 by a coil structure using one linear conductor. Hereinafter, of these coil structures, a configuration example of a coil structure in which a first inductor L1 and a second inductor L2 are connected will be described.

FIG. 19A is a front view of a first configuration example, and FIG. 19B is a top view thereof (plan view seen from a -Z-direction, the same applies hereinafter). In the first configuration example, a coil diameter Φ 1 of the first inductor L1 and a coil diameter Φ2 of the second inductor L2, and coil pitches (pitches between conducting wires, the same applies hereinafter) P1 and P2, and a transition turn pitch (coil pitch for distinguishing the first inductor L1 and the second inductor L2, the same applies hereinafter) P3 are different. This is to reduce an influence which a magnetic flux of the first inductor L1 has on the second inductor L2.

The second inductor L2 and the first inductor L1 are circular in the top view, as shown in FIG. 19B, but coil axes (center axes of coils, the same applies hereinafter) do not correspond to each other. In other words, the coil axes of the respective inductors L1 and L2 are parallel, but are separated by a fixed distance in the X-axis direction. Further, in the top view, the second inductor L2 is inscribed in the first inductor L1. Showing a size example, the coil diameter ϕ1 of the first inductor L1 is 12.0 m, the coil pitch P1 is 1.6 mm, the number of turns is 5.5 turns, and a transition portion from the first inductor L1 to the second inductor L2 is one turn. The coil diameter ϕ2 of the second inductor L2 is 8.0 mm, the coil pitch P2 is 0.53 mm, and the number of turns is seven turns. Here, the example in which the coil axes do not correspond to each other is described, but the coil axes may correspond to each other.

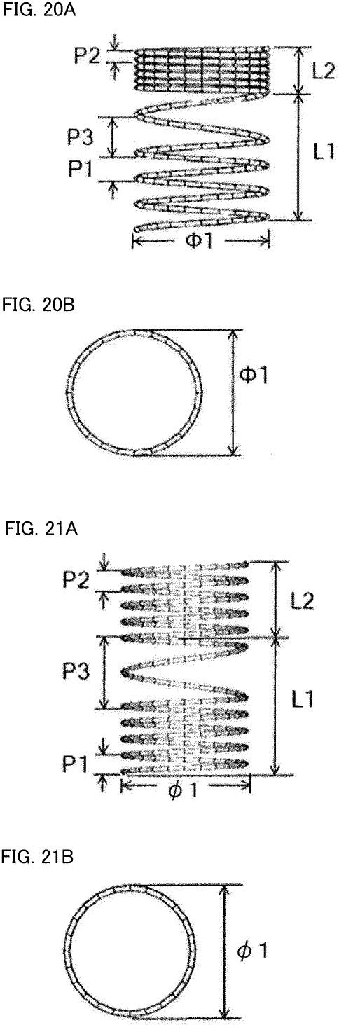

FIG. 20A is a front view of a second configuration example, and FIG. 20B is a top view thereof. In the second configuration example, coil diameters ϕ1 of the first inductor L1 and the second inductor L2 are the same, but coil pitches P1 and P2 are different. A transition turn pitch P3 is the same as in FIG. 19A. The second inductor L2 and the first inductor L1 are circular in the top view as shown in FIG. 20B, coil axes correspond to each other, and the coil diameters ϕ1 are equal. Therefore, both the inductors L1 and L2 overlap each other in an upward view. Showing a size example, the coil diameter Φ1 is 12.0 mm, a coil pitch P1 is 2.57 mm, the number of turns is 3.5 turns, and a transition portion from the first inductor L1 to the second inductor L2 is one turn. A coil diameter Φ2 of the second inductor L2 is 12.0 mm, a coil pitch P2 is 0.70 m, and the number of turns is six turns.

FIG. 21A is a front view of a third configuration example, and FIG. 21B is a top view thereof. In the third configuration example, coil diameters ϕ1 of the first inductor L1 and the second inductor L2 are the same, a coil pitch P1 and a coil pitch P2 are the same, and coil axes correspond to each other. A transition turn pitch P3 is different from the coil pitches P1 and P2 and is the same as in FIG. 19A. Since the first inductor L1 and the second inductor L2 are circular in top view, the coil axes are the same, and the coil diameters are the same as shown in FIG. 21B, both the inductors L1 and L2 overlap each other in top view.

Showing a size example, in both the first inductor L1 and the second inductor L2, the coil diameters ϕ1 are 12.0 mm, and the coil pitches P1 are 1.0 mm. The number of turns of the first inductor L1 is five turns, the number of turns of the second inductor L2 is 5.5 turns, and a transition portion from the first inductor L1 to the second inductor L2 is one turn. The transition turn pitch P3 is the same as in the cases of FIG. 19A and FIG. 20A. Further, the number of turns of the BEF according to the third configuration example is 10.5 turns, an inductance value of the first inductor is 306 nH, an inductance value of the second inductor is 448 nH, and a total of the inductance values is 754 nH.

When the transition portion is not mounted in the third configuration example, the gain is reduced because harmonics in the FM band occurs in a band range of the DTTV band. In this case, if isolation is obtained in a desired band range by another antenna or the like, for example, it is also possible to adopt a configuration in which the transition portion is shortened, or no transition portion is mounted in the third configuration example.

Further, as a characteristic required of the second inductor L2, by making the isolation between the first antenna portion 12 and the second antenna portion 13 -10.5 dB or less, it is possible to suppress gain reduction due to the harmonics in the FM waveband within 0.4 dB.

In other words, if the second inductor L2 alone can make the isolation -10.5 dB or less, it is possible to suppress reduction in gain in the DTTV band even if the AM/FM antenna and the DTV antenna are brought close to each other.

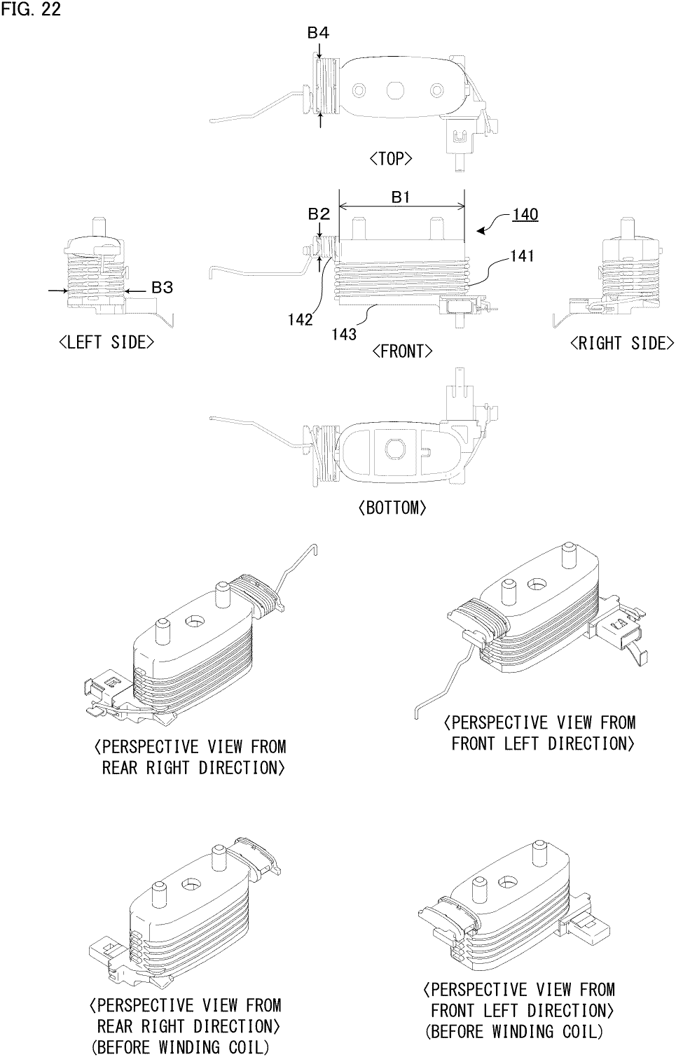

Next, a specific example of the coil structure will be described. FIG. 22 is an explanatory view showing a front view of a coil structure 140 to be an example, a left side view of the coil structure 140, a right side view of the coil structure 140, a top view of the coil structure 140, a bottom view of the coil structure 140, a perspective view of the coil structure 140 seen from a rear right direction, a perspective view of the coil structure 140 in a state before winding a coil seen from the rear right direction, a perspective view of the coil structure 140 seen from a front left direction, and a perspective view of the coil structure 140 in a state before winding the coil seen from a front left direction.

The coil structure 140 illustrated in FIG. 22 has a structure in which a helical element 141 to be the first inductor L1, and a BEF 142 (inductive element) to be the second inductor L2 are wound around a bobbin 143 that is an insulator. The coil structure 140 is mounted under the second antenna portion 13. As the bobbin 143, for example, a resin bobbin may be used, but instead of this, a resin holder for corresponding the entire second antenna portion 13 may be used as the bobbin 143. In order to avoid complicating the drawing, reference signs are omitted except for the front view in FIG. 22. In this example, the BEF 142 is one coil in which a linear conductor integrated with the helical element 141 is wound around the resin bobbin. In the FM band, the first inductor L1 functions as a tuning coil, whereby the inductors resonate in the FM band, but the second inductor L2 may be made a portion of the tuning coil.

A long diameter B1 of a portion around which the helical element 141 is wound of the bobbin 143 shown in the front view in FIG. 22 is 24.2 mm, and a short diameter B2 of a portion around which the BEF 142 is wound is 2.75 mm. A short diameter B3 of a portion around which the helical element 141 is wound, of the bobbin 143 shown in the left side view in FIG. 22 is 9.8 mm, and a long diameter B4 of a portion around which the BEF 142 is wound and shown in the top view in FIG. 22 is 8.8 mm.

By configuring the limiting circuit 51 by one coil like this, it is possible to reduce the number of components, and further reduce cost. Further, since this single coil can be manufactured by using an automatic winding machine or the like, productivity is improved compared with creating the limiting circuit 51 by combining separate components. In the resin bobbin, recesses are mounted in portions around which the linear conductor is wound, pitches (coil pitches in the present example) between adjacent conductors are equal, diameters of the helical element 141 (coil diameter in the present example) are the same, and a determined number of conductors can be wound. Therefore, it is possible to ensure stable electrical characteristics.

In the example shown in FIG. 22, center axes (coil axes in the present example) of the first inductor L1 and the second inductor L2 are orthogonal to each other. Therefore, the coil axes intersect each other. By making the coil axes orthogonal to each other, coupling of the first inductor L1 and the second inductor L2 is suppressed. Therefore, a size in the Z-direction can be made compacter than in the case where the second inductor L2 is arranged in the same winding direction above the first inductor L1, and low profile can be achieved. Further, by the coil structure like this, an advantage of being able to simplify management in design and manufacture is also obtained.

In the example shown in FIG. 22, the coil structure in which the first inductor L1 and the second inductor L2 are arranged so that the coil axes are orthogonal to each other is described, but a coil structure in which the first inductor L1 and the second inductor L2 are stacked in the coil axis direction (Z-direction) and connected in series may be adopted. In the coil structure in this case, the size in the Z-direction becomes long to a certain extent, but the physical lengths in the X-direction and the Y-direction can be shortened, and a degree of freedom in design on the antenna base 18 can be enhanced, as compared with the coil structure shown in FIG. 22.

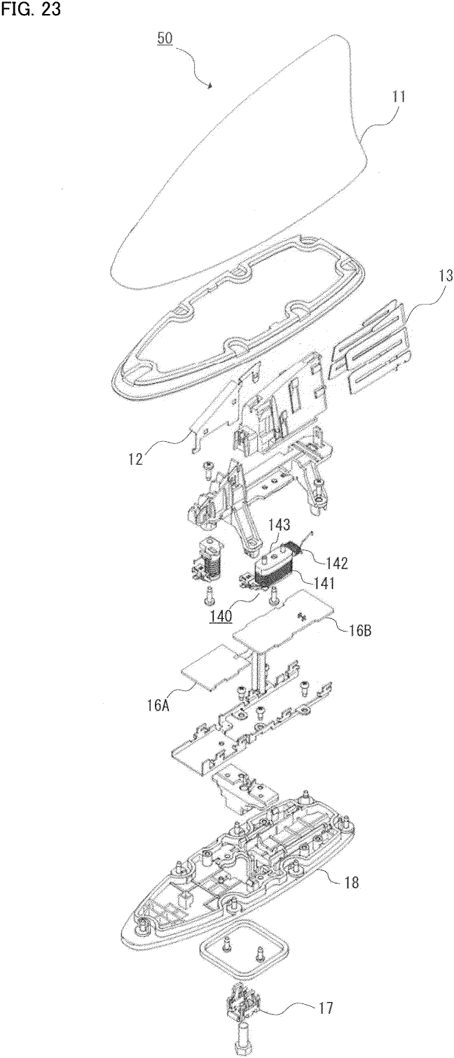

FIG. 23 is an exploded diagram of one example of the antenna device equipped with the coil structure 140 shown in FIG. 22. The antenna device is configured by accommodating a first antenna portion 12, a second antenna portion 13, the coil structure 140 including the helical element 141, the BEF 142 and the bobbin 143, circuit boards 16A and 16B and the like on an antenna base 18 that is sealed to be airtight and watertight by an antenna case 11, and mounting an attaching portion 17 on a bottom surface of the antenna base 18.

Further, in this example, the second antenna portion 13 is in a meander shape having one or more bent portions bent in a predetermined direction. As another mode, the second antenna portion 13 may have a shape having one or more curved portions curved in a predetermined direction.

Further, the second antenna portion 13 is not limited to the meander shape, but may be in another shape. FIG. 24 is a view showing a structure example of an umbrella-shaped second antenna portion 13″ as one example of the other shape. As illustrated, the second antenna portion 13″ in this example has a top portion T. It is shown that the top portion T overlaps the first antenna portion 12 in top view. The first antenna portion 12 and the second antenna portion 13″ may overlap each other in top view in this way, or may overlap each other in top view and side view.

In this way, according to the second embodiment, by mounting the limiting circuits 31 and 51, it is possible to suppress occurrence of harmonics (the third harmonic component f3 in the present example) of the FM band in the DTTV band, and enhance the gain in the DTTV band. The other effects are the same as the effects of the first embodiment.

The limiting circuits 31 and 51 may be configured to limit transmission of noise components emitted from elements (components, wiring or the like) other than the limiting circuits 31 and 51, besides the harmonics in the FM band. Since the noise component has various frequency components, it is possible to suppress reduction in gain in the DTTV band by also limiting transmission of the noise components like this.

Further, in the above explanation, the examples in which the limiting circuits 31 and 51 are interposed in only the second antenna portion 13 is shown, but a limiting circuit that limits transmission of signals with frequencies outside the DTTV band may also be mounted on the first antenna portion 12 side. In the limiting circuit like this, a limiting circuit (a low-cutoff filter, a bandpass filter, or the like without being limited to the BEF) that has high impedance in the AM/FM band, and/or harmonics of the FM band, or the above-described noise component, and has low impedance in the DTTV band may be interposed, for example. By the configuration like this, it is possible to suppress gain reduction in the DTTV band and the AM/FM band more remarkably.

Further, the above explanation is based on that the second antenna portion 13 exists above the circuit board 16B, but it is also possible to adopt a configuration in which the circuit board 16B is arranged forward of a front end of the second antenna portion 13, or rearward of a rear end of the second antenna portion 13, and a metal member does not exist directly under a capacitance loading element that is the second antenna portion 13. For example, it is possible to adopt a configuration in which the entire second antenna portion 13 exists on the circuit board 16B, and the second antenna portion 13 does not exist on a ground conductor and other metal plates. At this time, it is possible to integrate the circuit board 16A and the circuit board 16B to be a single circuit board.

According to the configuration, electrostatic capacity (stray capacitance) does not occur between the second antenna portion 13 and a metal member, and therefore, it is possible to enhance the gain in the AM/FM band.

Further, in the above explanation, the first antenna portion 12 is described as the antenna for DTTV, but it is possible to apply the present disclosure to an antenna for a higher frequency band than FM/AM frequencies, such as an antenna for SXM, an antenna for GNSS, an antenna for V2X (Vehicle to Everything), an antenna for telematics, an antenna for Wi-Fi, or an antenna for Bluetooth, without being limited to the antenna for DTTV. This also applies to modifications 1 to 4 below.

### [Modifications]

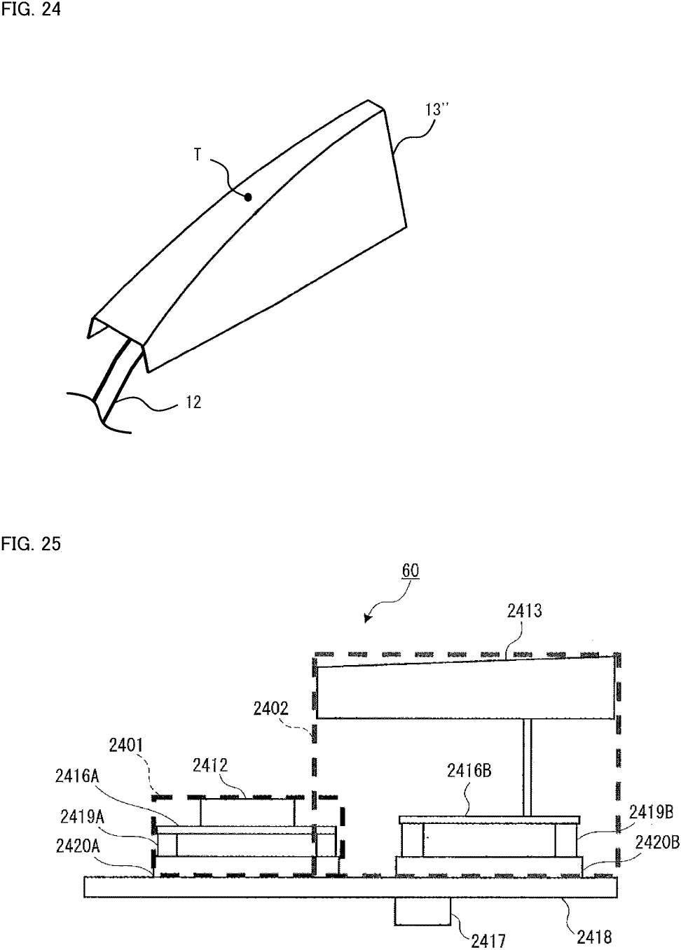

Next, a first modification to a fourth modification of the antenna device 10 will be described. FIG. 25 shows an antenna device 60 for a vehicle as a first modification. As illustrated, the antenna device 60 has a configuration in which a first antenna unit region 2401, and a second antenna unit region 2402 are mounted on a resin base 2418. The resin base 2418 is attached to a predetermined site of a vehicle via an attaching portion 2417. Further, the antenna device 60 has an antenna case (not illustrated) that forms an accommodation space with the resin base 2418. Since the antenna case of the first modification has a similar configuration to the configuration of the antenna case 11 in the first embodiment, explanation is omitted. The antenna unit region 2401 and the antenna unit region 2402 are located in the accommodation space.

The first antenna unit region 2401 is configured by a first antenna portion 2412 as an antenna element, a first circuit board 2416A, a tubular conductive base 2419A, and a conductive base 2420A in a flat plate shape. The second antenna unit region 2402 is configured by a second antenna portion 2413 as an antenna element, a second circuit board 2416B, a tubular conductive base 2419B, and a conductive base 2420B in a flat plate shape. In the first modification, the first circuit board 2416A is of a four-point type, four tubular conductive bases 2419A are mounted on the conductive base 2420A in a flat plate shape, and the first circuit board 2416A is mounted on the four tubular conductive bases 2419A. This also applies to a second modification, a third modification and a fourth modification that are described later. The tubular conductive bases 2419A and 2419B can be conductive and each may be a conductor in a screw shape or a pin shape, or may be a conductor in a rod shape, a columnar shape or a conical shape, for example.

The first antenna portion 2412 is configured by a planar antenna, and functions as an SXM antenna configured by a patch antenna in the illustrated example. The second antenna portion 2413 functions as an antenna corresponding a second frequency band similarly to the first antenna portion 12 of the antenna device 10, as a portion of the AM/FM band antenna in the present example.

The first antenna portion 2412 is not limited to an SXM antenna, but may be a DTTV band antenna, a GNSS antenna, or a V2X antenna. Further, the planar antenna means an antenna having a plane portion, includes, for example, a planar antenna, an antenna formed by a microstrip line, a patch antenna and the like, and an antenna method such as a dipole or monopole is not limited.

By the configuration like this, the first antenna unit region 2401 functions as the planar antenna unit corresponding a first frequency band, and the second antenna unit region 2402 functions as an antenna unit corresponding AM/FM that is a second frequency band.

As illustrated, a length in side view of the first antenna unit region 2401 is a length in a left-right direction in the drawing, that is, the X-axis direction. In detail, the length is a maximum length including the first antenna portion 2412, the first circuit board 2416A, the tubular conductive bases 2419A, and the conductive base 2420A in a flat plate shape that configure the first antenna unit region 2401. As illustrated, the length is defined by a left end and a right end of the conductive base 2420A.

A length in a vertical direction of the first antenna unit region 2401, that is, in the Z-axis direction is a maximum length including the first antenna portion 2412 and the like that configure the first antenna unit region 2401 and is defined by a lower end of the conductive base 2420A and an upper end of the first antenna portion 2412 as illustrated.

A length in a depth direction of a paper surface of the first antenna unit region 2401, that is, in the Y-axis direction is a maximum length including the first antenna portion 2412 and the like that configure the first antenna unit region 2401. In this example, the length is defined by a maximum length in the Y-axis direction of the first circuit board 2416A though not illustrated.

A length in side view of the second antenna unit region 2402 is a length in the left-right direction in the drawing, that is, in the X-axis direction. In detail, the length is a maximum length including the second antenna portion 2413, the second circuit board 2416B, the tubular conductive bases 2419B, and the conductive base 2420B in a flat plate shape and is defined by a left end and a right end of the second antenna portion 2413 as illustrated.

A length in the vertical direction of the second antenna unit region 2402, that is, in the Z-axis direction is a maximum length including the second antenna portion 2413 and the like that configure the second antenna unit region 2402 and is defined by a lower end of the conductive base 2420B and an upper end of the second antenna portion 2413 as illustrated.

A length in a depth direction of a paper surface of the second antenna unit region 2402, that is, in the Y-axis direction is a maximum length including the second antenna portion 2413 and the like that configure the second antenna unit region 2402. In this example, the length is defined by a maximum length in the Y-axis direction of the second circuit board 2416B though not illustrated.

In the first antenna unit region 2401 and the second antenna unit region 2402 shown in FIG. 25, a portion of the region of the first antenna unit region 2401 and a portion of the region of the second antenna unit region 2402 overlap each other in each of top view, side view and front view. The same also applies to FIGS. 26 to 28 below.

Both the resin base 2418 and an attaching portion 2417 are not included in either the first antenna unit region 2401 or the second antenna unit region 2402.

FIG. 26 shows an antenna device 70 for a vehicle as the second modification. The antenna device 70 does not have a resin base. Further, in the antenna device 60, separate conductive bases that are a conductive base 2420A and a conductive base 2420B are used, whereas in the antenna device 70, instead of these conductive bases, a conductive base 2420 in a flat plate shape that is common to a first circuit board 2416A and a second circuit board 2416B is used. The other configurations are similar to the configurations of the antenna device 60.

As illustrated, an attaching portion 2417 is mounted so that a left end of the attaching portion 2417 substantially corresponds to a left end of the second circuit board 2416B in side view. A length in side view of a first antenna unit region 2401 is a length in a left-right direction in the drawing, that is, in the X-axis direction. In detail, the length is a maximum length including a first antenna portion 2412, the first circuit board 2416A, tubular conductive bases 2419A, and a portion in contact with the attaching portion 2417, of the conductive base 2420 in a flat plate shape, that configure the first antenna unit region 2401. As illustrated, the length is defined by a left end of the conductive base 2420 and a right end of the attaching portion 2417.

The reason why the length in side view of the first antenna unit region 2401 includes the portion in contact with the attaching portion 2417, of the conductive base 2420 in the flat plate shape will be described.

When an antenna and a circuit operate, a harmonic current also flows in a ground portion (for example, a ground pattern) of a circuit board, an earth portion of a conductive base and the like. When the earth portion of the conductive base is connected to a vehicle roof or the like via an attaching portion, a high frequency current also flows from the conductive base to the attaching portion, and therefore, has an influence on the other antenna unit. Consequently, the antenna unit region is defined to a length in side view of the first antenna unit region 2401 including the portion in contact with the attaching portion 2417, of the conductive base 2420 in the flat plate shape.

For example, an earth portion of the conductive base 2420 is connected to a vehicle roof or the like via the attaching portion 2417, a high frequency current flows toward the attaching portion 2417 from the first antenna unit region 2401, and reaches the vehicle roof. The attaching portion 2417 is electrically coupled with the vehicle roof and is sufficiently grounded. Accordingly, the high frequency current of the first antenna unit region 2401 does not flow to a rear side from the attaching portion 2417.

A length in the vertical direction of the first antenna unit region 2401, that is, in the Z-axis direction is a maximum length including the first antenna portion 2412, the first circuit board 2416A, the tubular conductive bases 2419A, and the portion in contact with the attaching portion 2417, of the conductive base 2420 in the flat plate shape that configure the first antenna unit region 2401, and is defined by a lower end of the conductive base 2420 and an upper end of the first antenna portion 2412 as illustrated.

A length in a depth direction of the paper surface of the first antenna unit region 2401, that is, in the Y-axis direction is a maximum length including the first antenna portion 2412, the first circuit board 2416A, the tubular conductive bases 2419A, and the portion in contact with the attaching portion 2417, of the conductive base 2420 in the flat plate shape that configure the first antenna unit region 2401, and is defined by a maximum length in the Y-axis direction of the first circuit board 2416A in this example, though not illustrated.

Similarly, a length in side view of the second antenna unit region 2402 is defined by a left end and a right end of a second antenna portion 2413 in a length in a left-right direction (X-axis direction) in the drawing, and a length in the vertical direction (Z-axis direction) is defined by the lower end of the conductive base 2420 and an upper end of the second antenna portion 2413.

Further, a length in a depth direction of the paper surface of the second antenna unit region 2402, that is, in the Y-axis direction is defined by a maximum length in the Y-axis direction of the second circuit board 2416B though not illustrated.

The attaching portion 2417 is not included in either the first antenna unit region 2401 or the second antenna unit region 2402.

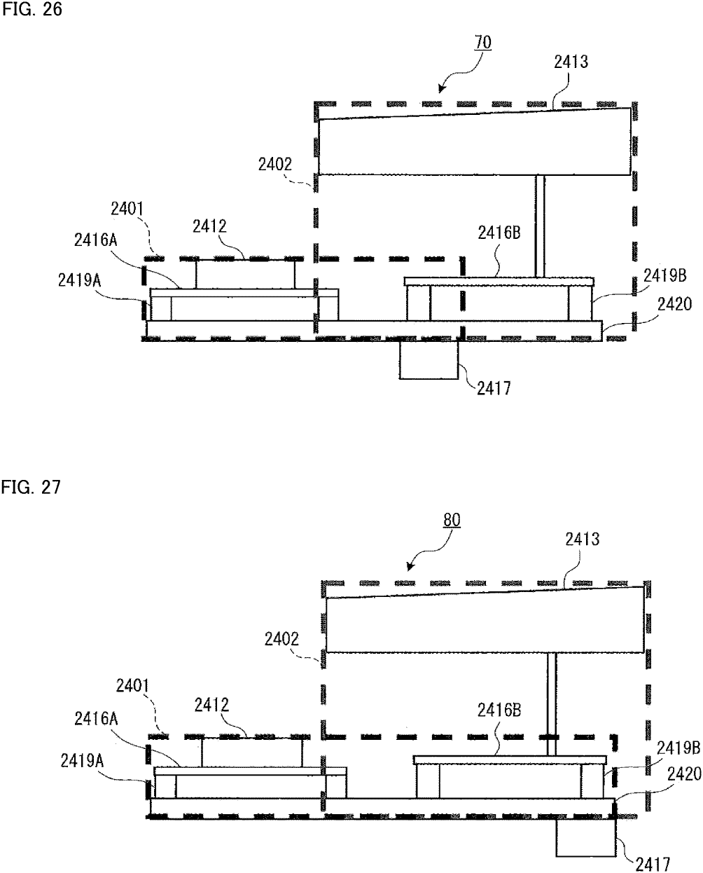

FIG. 27 shows an antenna device 80 for a vehicle as a third modification. In the antenna device 80, an attaching portion 2417 is mounted so that a right end of the attaching portion 2417 corresponds to a right end of a conductive base 2420 in side view, and other configurations are similar to the configurations of the antenna device 70. As illustrated, a length in side view of a first antenna unit region 2401 is a length in a left-right direction in the drawing, that is, in the X-axis direction. In detail, the length is a maximum length including a first antenna portion 2412, a first circuit board 2416A, tubular conductive bases 2419A, and a portion in contact with the attaching portion 2417, of the conductive base 2420 in a flat plate shape that configure the first antenna unit region 2401. As illustrated, the length is defined by a left end of the conductive base 2420, and the right end of the attaching portion 2417.

A length in the vertical direction of the first antenna unit region 2401, that is, in the Z-axis direction is a maximum length including the first antenna portion 2412 and the like that configure the first antenna unit region 2401, and is defined by a lower end of the conductive base 2420 and an upper end of the first antenna portion 2412 as illustrated.

A length in a depth direction of a paper surface of the first antenna unit region 2401, that is, in the Y-axis direction is a maximum length including the first antenna portion 2412 and the like that configure the first antenna unit region 2401. In this example, the length is defined by a maximum length in the Y-axis direction of the first circuit board 2416A, though not illustrated.

Further, a length in side view of a second antenna unit region 2402 is a length in a left-right direction in the drawing, that is, in the X-axis direction. In detail, the length is a maximum length including a second antenna portion 2413, a second circuit board 2416B, a tubular conductive base 2419B, and the conductive base 2420 in the flat plate shape that configure the second antenna unit region 2402, and is defined by a left end and a right end of the second antenna portion 2413 as illustrated.

A length in the vertical direction of the second antenna unit region 2402, that is, in the Z-axis direction is a maximum length including the second antenna portion 2413 and the like that configure the second antenna unit region 2402, and is defined by a lower end of the conductive base 2420 and an upper end of the second antenna portion 2413 as illustrated.

The attaching portion 2417 is not included in either the first antenna unit region 2401 or the second antenna unit region 2402.

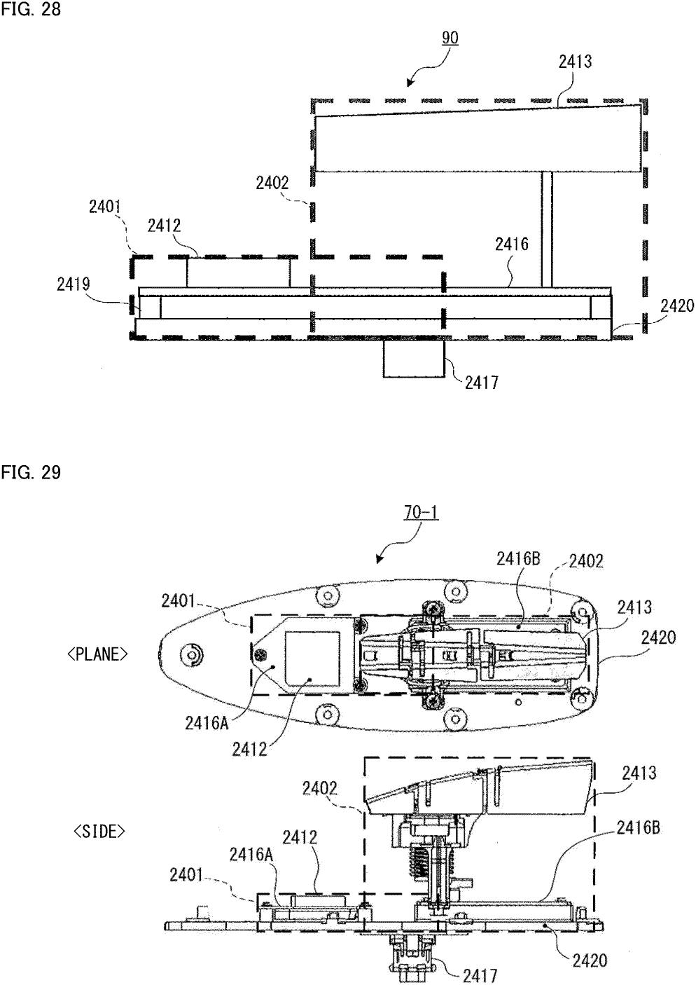

FIG. 28 shows an antenna device 90 for a vehicle as a fourth modification. As compared with the antenna device 70 of the second modification, the antenna device 90 is different in that a first antenna portion 2412 and a second antenna portion 2413 are mounted on a common circuit board 2416. Further, the circuit board 2416 is arranged on tubular conductive bases 2419. The tubular conductive base 2419 is mounted on a conductive base 2420 in a flat plate shape. Other configurations are similar to the configurations of the antenna device 70.

Similarly to the antenna device 70, in the antenna device 90, a length in side view of a first antenna unit region 2401 is a length in a left-right direction in the drawing, that is, in the X-axis direction. In detail, the length is a maximum length including the first antenna portion 2412 a portion in contact with the attaching portion 2417, of the conductive base 2420 in the flat plate shape that configure the first antenna unit region 2401.

As illustrated, the length is defined by a left end of the conductive base 2420, and a right end of the attaching portion 2417.

A length in the vertical direction of the first antenna unit region 2401, that is, in the Z-axis direction is a maximum length including the first antenna portion 2412 and the like that configure the first antenna unit region 2401, and is defined by a lower end of the conductive base 2420 and an upper end of the first antenna portion 2412 as illustrated.

A length in a depth direction of a paper surface of the first antenna unit region 2401, that is, in the Y-axis direction is a maximum length including the first antenna portion 2412 and the circuit board 2416 that configure the first antenna unit region 2401. In this example, the length is defined by a maximum length in the Y-axis direction of the circuit board 2416 though not illustrated.

A region in side view of a second antenna unit region 2402 is defined by a left end and a right end of the second antenna portion 2413 in the left-right direction in the drawing (X-axis direction), and a region in the vertical direction (Z-axis direction) is defined by the lower end of the conductive base 2420 and an upper end of the second antenna portion 2413.

A length in the depth direction (Y-axis direction) of the paper surface of the first antenna unit region 2401 is defined by the maximum length in the Y-axis direction of the circuit board 2416 though not illustrated.

The attaching portion 2417 is not included in either the first antenna unit region 2401 or the second antenna unit region 2402.

Hereinafter, characteristics that are common to the first modification to the fourth modification will be described. In each of these modifications, the first antenna portion 2412 and the second antenna portion 2413 are in a positional relationship in which the first antenna portion 2412 and the second antenna portion 2413 do not overlap each other. In other words, antenna elements do not overlap each other. However, a portion of the region of the first antenna unit region 2401 and a portion of the region of the second antenna unit region 2402 overlap each other in each of top view, side view and front view. By adopting the configuration in which the portion of the region of the first antenna unit region 2401 and the portion of the second antenna unit region 2402 overlap each other in top view, side view and front view in this way, it is possible to reduce a proprietary area of these regions, make the design of the antenna device 60 compact, and effectively use an internal region of a case design.

The portion of the region of the first antenna unit region 2401 and the portion of the second antenna unit region 2402 do not have to overlap each other in all of top view, side view and front view, but may overlap each other in at least one of these views. The first antenna unit region 2401 and the second antenna unit region 2402 may be each in a triangular shape or a trapezoidal shape in top view. Especially in the case of a shark fin antenna (SF antenna), a shape of the antenna becomes thinner toward a tip end in top view, and therefore, it is possible to effectively use an internal region by making the component such as the circuit board of at least one of the first antenna unit region 2401 and the second antenna unit region 2402 triangular or trapezoidal and tapering on a side of a tip end correspondingly to the shape of the SF antenna. Since the first antenna unit region 2401 is located more forward in the antenna device than the second antenna unit region 2402, and exists in a tapering position, it is possible to effectively use the internal region by making the component of the first antenna unit region 2401 triangular or trapezoidal.

FIG. 29 shows an antenna device 70-1 for a vehicle in which the first circuit board 2416A is of a three-point type in the second modification shown in FIG. 26. As described above, in each of the first modification to the fourth modification, the circuit board 2416A is of a four-point type. However, the first circuit board 2416A may be of a three-point type. The example of FIG. 29 is configured such that three tubular conductive bases 2419A are mounted on a conductive base 2420 in a flat plate shape, and the first circuit board 2416A is mounted on the three tubular conductive bases 2419A. The drawing shows that by mounting one of the tubular conductive bases 2419A on a tapering front side of the first circuit board 2416A, a front region in a case is reduced, and design can be improved.

Further, a first antenna unit region 2401 and a second antenna unit region 2402 in a schematic plan view and a schematic side view in FIG. 29 correspond to the first antenna unit region 2401 and the second antenna unit region 2402 that are rectangular parallelepipeds each in a maximum size in FIG. 26, and regions of these antenna unit regions are similarly defined. Though not shown in FIG. 26, the plan view in FIG. 29 shows that a length in the Y-axis direction of the first antenna unit region 2401 is defined by a maximum length in the Y-axis direction of the first circuit board 2416A.

Further, FIG. 29 also shows that a portion of a region of the first antenna unit region 2401 and a portion of a region of the second antenna unit region 2402 overlap each other in all of top view, side view and front view.

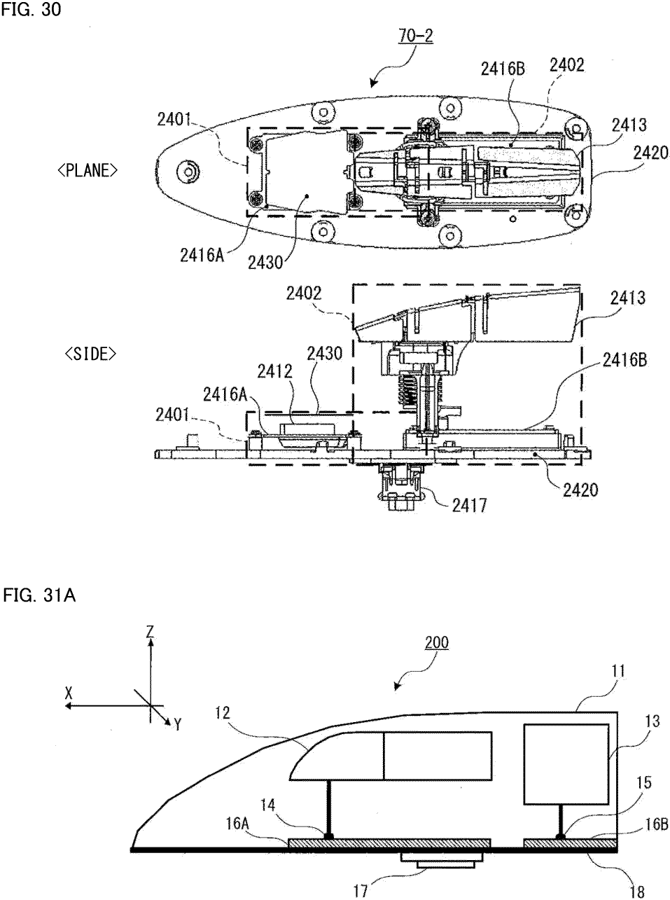

FIG. 30 shows an antenna device 70-2 for a vehicle in which a parasitic element 2430 is arranged on the first antenna portion 2412 in the second modification. In this way, a configuration in which the parasitic element is mounted on the first antenna portion 2412 may be adopted. Similarly, a configuration in which a parasitic element is mounted on a second antenna portion 2413 may also be adopted.

Further, a first antenna unit region 2401 and a second antenna unit region 2402 in a schematic plan view and a schematic side view in FIG. 30 correspond to the first antenna unit region 2401 and the second antenna unit region 2402 that are the rectangular parallelepipeds each in the maximum size in FIG. 26, and regions of these antenna unit regions are similarly defined. The plan view in FIG. 30 shows that a length in the Y-axis direction of the first antenna unit region 2401 is also defined by a maximum length in the Y-axis direction of a first circuit board 2416A.

Further, FIG. 30 shows that a portion of a region of the first antenna unit region 2401 and a portion of a region of the second antenna unit region 2402 also overlap each other in all of top view, side view and front view.

Hereinafter, a characteristic about the first modification will be described. A conductive base is a component electrically connected to a ground portion of a circuit board, and when an antenna operates, a current flows to the conductive base via the ground portion of the circuit board. A current flows in each of the respective conductive base 2416A and the like in the first antenna unit region 2401 and the second antenna unit region 2402 in FIG. 25.

Here, in order to reduce an influence on other media, the first antenna unit region 2401 and the second antenna unit region 2402 desirably use separate conductive bases. Further, in general, it is more advantageous in terms of cost to use two conductive bases each having an area approximately half an area of a large conductive base than to use the single large conductive base.

As described above, in the first modification, the conductive base 2419A and the conductive base 2420A of the first antenna unit region 2401, and the conductive base 2419B and the conductive base 2420B of the second antenna unit region 2402 are respectively separate. Accordingly, the advantages of reducing the influence on the other media, being advantageous in terms of cost and the like that are described above are obtained. For the conductive base, either die-cast or plate may be used. Further, when the first antenna unit region 2401 is an antenna unit for SXM or DTTV band, the conductive base may not be connected directly to the vehicle roof.

On the other hand, in each of the second modification to the fourth modification, the configuration of the common base in which the first antenna unit region 2401 and the second antenna unit region 2402 are connected by the common conductive base 2420 is adopted. In each of them, a current flows to the vehicle roof, so that the region including the attaching portion 2417 is the region that configures the antenna.

Next, a characteristic common to the first modification, the second modification and the third modification will be described. In each of these modifications, the configuration in which the first antenna unit region 2401 and the second antenna unit region 2402 use the separate circuit boards that are the first circuit board 2416A and the second circuit board 2416B. In general, it is more advantageous in terms of cost to use two circuit boards each having an area approximately half an area of a large circuit board than to use the single large circuit board. Accordingly, it is possible to suppress the cost of the board by using separate boards. Further, in the first circuit board 2416A and the second circuit board 2416B, the respective heights can be freely set. In this case, it is also possible to suppress mechanical and electrical interferences by individually adjusting the heights of the circuit boards.

In the fourth modification, the common circuit board 2416 is used in the first antenna unit region 2401 and the second antenna unit region 2402. In the case of the single board like this, it is possible to reduce the number of components, it is also possible to complete board assembly work by one step, and an advantage is obtained that a manufacturing process can be simplified. Further, the planar antenna is preferably placed close to the vehicle roof so as to have directivity to an upper side from a horizontal plane. Here, in each of the first modification, the second modification and the third modification, the first circuit board 2416A is arranged at a position lower than the second circuit board 2416B. In other words, the board on the planar antenna side is arranged to be lower than the board on the side of a nonplanar antenna, and is also advantageous in terms of directivity.

### <Operational Effect by Embodiments>

The antenna devices described in the above-described embodiments each include the antenna base 18, the antenna case 11 forming the accommodation space with the antenna base 18, the first antenna portion 12 accommodated in the accommodation space and corresponding the first frequency band, and the second antenna portion 13 accommodated in the accommodation space and corresponding the second frequency band lower than the first frequency band, and can exhibit various operational effects by further adopting the configurations below.

A configuration in which a first antenna portion 12 and a second antenna portion 13 each includes one or more elements, portion of the elements of the first antenna portion 12 overlaps portion of the elements of the second antenna portion 13 in side view and/or top view, a limiting circuit is connected to a power feeding portion of at least one antenna portion of the first antenna portion 12 and the second antenna portion 13, and the limiting circuit limits transmission of signals with frequencies outside a frequency band corresponded by the antenna portion. In other words, a configuration in which at least a portion of a region (for example, a region 211) of the first antenna portion 12 and at least a portion of a region (for example, a region 212) of the second antenna portion 13 overlap each other, a limiting circuit (for example, a limiting circuit 31) is connected to a power feeding portion of at least one antenna portion of the first antenna portion 12 and the second antenna portion 13, and the limiting circuit limits transmission of signals with frequencies outside a frequency band corresponded by the antenna portion. According to the configuration, a difference between a maximum value and a minimum value of gain in the first frequency band is reduced, and it is possible to broaden a band of usable frequencies. Further, it becomes possible to arrange these antenna portions 12 and 13 close to each other in the limited space while suppressing degradation of the antenna characteristics of the first antenna portion 12 and the second antenna portion 13. Therefore, it becomes easy to make the antenna device compact.

(2) A configuration in which the first antenna portion 12 includes an element having one or more bent portions bent in a width direction in top view of the first antenna portion 12, for example, a third element 123. According to this configuration, it is possible to further reduce a total value of lengths in the above-described longitudinal direction without changing electrical lengths of the elements of the first antenna portion 12.

A configuration in which an element of the second antenna portion 13 is caused to act as a capacitance loading element that loads capacitance to an element of the first antenna portion 12. It is well-known that the element of the second antenna portion 13 acts as the capacitance loading element to the coil in the AM/FM band, but it is not general that the element of the second antenna portion 13 loads capacitance to the element of the first antenna portion 12. According to this configuration, it is possible to enlarge an electrical antenna size without changing the physical length of the element of the first antenna portion 12.

A configuration in which a plurality of gaps are formed in the element of the second antenna portion 13. According to the configuration, it becomes possible to attach the second antenna portion 13 by only fitting projections or the like of an insulator holder (not illustrated) that is fixed to the antenna case 11 or the antenna base 18 into the gaps, for example, and in addition, adjustment of the electrical length of the elements of the second antenna portion 13 is facilitated.

A configuration in which portion or all of the elements of the second antenna portion 13 are a plate-shaped conductor in a fractal shape with the gaps, a meander shape or a shape partially including these shapes. According to the configuration, fine tuning of the above-described electrical length and antenna characteristics is further facilitated.

(6) A configuration in which to the first antenna portion 12 (for example, a first element 121) or a power feeding portion (for example, a connection element 133) of the second antenna portion 13, a limiting circuit (for example, the limiting circuit 31) that limits transmission of a frequency band corresponded by the other antenna portion is connected. According to the configuration, even when the elements of the two antenna portions for different frequency bands are arranged so close to each other that portions thereof overlap each other, interference is prevented, and reduction in gain is suppressed.

A configuration in which the limiting circuit is a filter that limits transmission of at least one of a signal in the second frequency band, a signal of a harmonic component in the second frequency band, and a noise component emitted from an element other than the limiting circuit, in a power feeding portion of the first antenna portion 12. In this configuration, reduction in gain in the first frequency band and the second frequency band is suppressed.

A configuration in which the limiting circuit is a filter that limits transmission of at least one of a signal in the first frequency band, a signal of a harmonic component in the second frequency band, and a noise component emitted from an element other than the limiting circuit, in the power feeding portion of the second antenna portion 13. In this configuration, reduction in gain in the first frequency band and the second frequency band is suppressed.

(9) A configuration in which a first inductor L1 is connected to the power feeding portion of the second antenna portion 13, and the limiting circuit 31 or the like is a second inductor L2 that is connected in series to the first inductor L1. According to the configuration, it is possible to realize the limiting circuit by using the self-resonance of the inductor element having a coil structure, for example, and therefore, it is possible to reduce the number of components of the antenna device 10 or the like.

A configuration in which the first inductor L1 includes a first helical element, and the second inductor L2 includes a second helical element configured by a linear conductor integrated with the first helical element. According to the configuration, it is possible to realize the helical element that cooperates with the second antenna portion 13 and the limiting circuit 31 or the like by only the single linear conductor, and therefore, the manufacturing process of the antenna device 10 or the like is simplified.

A configuration in which a diameter of the first helical element and a diameter of the second helical element are different from each other. According to the configuration, it is possible to distinguish between the first helical element that cooperates with the second antenna portion 13 and the second helical element that operates as the limiting circuit 31 or the like, so that antenna design work is simplified as compared with the case in which the diameters are the same.

A configuration in which a pitch between conducting wires of the first helical element and a pitch between conducting wires of the second helical element are different from each other. According to the configuration, it is possible to distinguish between the first helical element that cooperates with the second antenna portion 13 and the second helical element that operates as the limiting circuit 31 or the like, so that antenna design work is simplified as compared to the case in which the pitches between conducting wires are the same.

A configuration in which coil axes that are respective center axes of the first helical element and the second helical element intersect each other. According to the configuration, it is possible to reduce a height in the Z-direction as compared with the case in which the coil axes are same, in addition to that coupling between the respective helical elements is avoided.

(14) A configuration in which the first helical element and the second helical element are wound around a same insulator. According to the configuration, the manufacturing process of the antenna device 10 or the like is simplified, and it becomes possible to save an installation space for the respective antenna portions 12 and 13 on the antenna base 18. Further, it is possible to enhance the degree of freedom of the installation position of the insulator. Furthermore, it is possible to reduce the number of components of the antenna device, and it is also possible to reduce the length in the front-rear direction and the space in the height direction.

A configuration in which the circuit board 16B is arranged further forward from a front end of the second antenna portion 13, and a metal member does not exist directly under a capacitance loading element that is the second antenna portion 13. For example, a configuration in which the entire second antenna portion 13 exists on the circuit board 16B, and the second antenna portion 13 does not exist on the ground conductor or other metal plates. According to the configuration, a stray capacitance in the second antenna portion 13 does not occur, so that it is possible to improve gain in the AM/FM band.

A configuration in which the circuit board 16A for the DTTV band and the circuit board 16B for the AM/FM band are handled with one board. According to the configuration, the single circuit board is used, and thereby it is possible to reduce the number of components of the antenna device 10 or the like.

A configuration in which the first inductor L1 and the second inductor L2 are separately configured. According to the configuration, it is possible to retrofit the first inductor L1 and the second inductor L2, add these inductors are added as appropriate according to the installation environment, or change the inductance of each of the inductors L1 and L2 as appropriate.

A configuration in which the second inductor L2 is densely wound. According to the configuration, it is possible to tune the second inductor L2 to a self-resonant frequency in the DTTV band. The second inductor L2 can ensure better isolation when the second inductor L2 has a densely-wound configuration than a non-densely-wound configuration.

(19) A configuration in which in any of top view, side view and front view, at least a portion of the region of the first antenna portion, and at least a portion of the region of the second antenna portion overlap each other. According to the configuration, the difference between the maximum value and the minimum value of the gain in the first frequency band decreases, and it is possible to broaden the band of the usable frequencies. Further, it is possible to arrange these antenna portions 12 and 13 closely to each other in the limited space while suppressing degradation of the antenna characteristics of the first antenna portion 12 and the second antenna portion 13. Therefore, it becomes easy to make the antenna device compact.

A configuration in which at least one of the first antenna portion and the second antenna portion includes an element including one or more bent portions bent in a predetermined direction or a curved portion curved in a predetermined direction. According to the configuration, it is possible to further shorten the total value of the lengths in the longitudinal direction without changing the electrical length of the elements of at least one of the first antenna portion and the second antenna portion.

In the first embodiment and the second embodiment, it is also possible to load the antenna device on mobile objects equivalent to vehicles, such as ships and trains, except for objects that are carried by people such as mobile terminals not limited to vehicles.

1. An antenna device for a vehicle, comprising:
an antenna base that is attached to a predetermined site of a vehicle;
an antenna case forming an accommodation space with the antenna base;
a first antenna portion accommodated in the accommodation space and corresponding a first frequency band; and
a second antenna portion accommodated in the accommodation space and corresponding a second frequency band lower than the first frequency band,
wherein at least a portion of a region of the first antenna portion and at least a portion of a region of the second antenna portion overlap each other, and
wherein a limiting circuit is connected to a power feeding portion of at least one antenna portion of the first antenna portion and the second antenna portion, and
wherein the limiting circuit limits transmission of signals with frequencies outside a frequency band corresponded by the antenna portion.

2. The antenna device for the vehicle according to claim 1,
wherein at least a portion of the region of the first antenna portion and at least a portion of the region of the second antenna portion overlap each other in any of top view, side view and front view.

3. The antenna device for the vehicle according to claim 1,
wherein at least one of the first antenna portion and the second antenna portion includes an element including one or more bent portions bent in a predetermined direction or a curved portion curved in a predetermined direction.

4. The antenna device for the vehicle according to claim 1,
wherein the limiting circuit is a filter that limits transmission of at least one of a signal in the second frequency band, a signal of a harmonic component in the second frequency band, and a noise component emitted from an element other than the limiting circuit, in a power feeding portion of the first antenna portion.

5. The antenna device for the vehicle according to claim 1,
wherein the limiting circuit is a filter that limits transmission of at least one of a signal in the first frequency band, a signal of a harmonic component in the second frequency band, and a noise component emitted from an element other than the limiting circuit, in a power feeding portion of the second antenna portion.

6. The antenna device for the vehicle according to claim 4,
wherein a first inductor is connected to a power feeding portion of the second antenna portion, and
the limiting circuit is a second inductor that is connected in series to the first inductor.

7. The antenna device for the vehicle according to claim 6,
wherein the first inductor includes a first helical element, and the second inductor includes a second helical element configured by a linear conductor integrated with the first helical element.

8. The antenna device for the vehicle according to claim 7,
wherein a diameter of the first helical element and a diameter of the second helical element are different from each other.

9. The antenna device for the vehicle according to claim 7,
wherein a pitch between conducting wires of the first helical element and a pitch between conducting wires of the second helical element are different from each other.

10. The antenna device for the vehicle according to claim 8,
wherein respective center axes of the first helical element and the second helical element intersect each other.

11. The antenna device for the vehicle according to claim 7,
wherein the first helical element and the second helical element are wound around a same insulator.

12. The antenna device for the vehicle according to claim 4,
wherein a first inductor is connected to a power feeding portion of the second antenna portion, and
the limiting circuit is one or more reactance elements that are connected in series to the first inductor.

13. The antenna device for the vehicle according to claim 9,
wherein respective center axes of the first helical element and the second helical element intersect each other.
